(19) United States
(12) Patent Application Publication
(10) Pub. No.: US 2006/0065002 A1
(43) Pub. Date: Mar. 30, 2006

(54) System and method for extracting potable water from atmosphere

(75) Inventor: Diego Luis Felipe Bernardo Castanon Seoane, Lima (PE)

Correspondence Address: Diego Castanon Secane;Honduras 330, Lima 18, Peru, PE

(73) Assignee: HUMANO, LTD., Hamilton (BM)

(21) Appl. No.: 11/017,856

(22) Filed: Dec. 22, 2004

Related U.S. Application Data
(63) Continuation-in-part of application No. 10/949,249, filed on Sep. 27, 2004.

(51) Int. Cl. F25D 17/06; C08J 3/00; C08K 3/00; F25D 21/00; F25D 21/14; C08L 25/00; C08L 9/00

(52) U.S. Cl. 62/291; 62/93; 62/272

(57) ABSTRACT

A system for producing potable water from atmosphere includes an enclosure with at least one intake port and exhaust port. The system includes a plurality of panels arranged within the enclosure substantially parallel to each other along a central axis. Each of the panels is made of a material on which water condensate from the atmosphere forms in response to a temperature differential between the material and the atmosphere passed through the enclosure. The system includes a plurality of conduits arranged to pass through the panels. A cooling fluid is passed through the conduits to cool the panels. The amount of water condensate formed on surfaces of the panels in response to cooling is detected. The panels are rotated about the central axis within the enclosure to remove the water condensate from the surfaces of the panels when the detected amount of water condensate exceeds a predetermined threshold.

This application is a continuation-in-part of U.S. application Ser. No. 10/949,249, filed Sep. 27, 2004, the entire contents of which are incorporated by reference herein.

### BACKGROUND

1. Field of the Invention

The present invention relates to the production of potable water. More particularly, the present invention relates to a system and method for extracting potable water from the atmosphere.

2. Background Information

Generally, natural freshwater resources are scarce or limited in many areas of the world, including areas such as, for example, deserts and arid lands, due to low precipitation and high salinity of surface and underground water. Shortage in supply of potable water and fresh water is increasing at a vast rate, as deserts expand and overtake fertile land, and as many of the natural ground water resources are being depleted. Furthermore, shifts in patterns of the global climate over time have resulted in a drop in the rate of rainfall in many areas. For example, hunger and starvation is spreading in areas such as, for example, Africa, because of shortage of fresh water to raise domestic animals and crops for food.

Sparse population and scattered population pockets in many areas make the application of water desalination and other water treatment technologies uneconomical due to the low demand and the high cost of water distribution from a central system over a wide stretch of land. For example, such methods of supplying potable water may be inaccessible to remote and/or impoverished areas of the world due to lack of natural resources, wealth, infrastructure and technical expertise. Alternatively, transportation of loads of fresh water is costly and exposes water to contamination en route and during handling and storage. For example, remote areas of the world may lack the necessary transportation infrastructure to allow transportation of potable water to these remote areas.

Accordingly, there is a need for localized production of fresh water to provide water for human drinking, and fresh water for raising animals and for irrigation as well as other human uses, that is reliable, affordable and produces little or no industrial pollution. Additionally, there is a need that the system may be transported and assembled in a number of remote areas inhabited by humans where little or no natural resources are available for providing potable water. The apparatus should be accessible to individuals with limited technical expertise and be available in a range of sizes so that it may be used in areas that lack abundant space.

### SUMMARY OF THE INVENTION

A system and method are disclosed for extracting potable water from the atmosphere. In accordance with exemplary embodiments of the present invention, according to a first aspect of the present invention, a system for producing potable water from the atmosphere includes a first surface and a second surface arranged substantially parallel to the first surface. The first and second surfaces are comprised of a material on which water condensation from the atmosphere forms in response to a temperature differential between the material and the atmosphere. A seal is formed around a periphery of the first and second surfaces to form an enclosure between the first and second surfaces. The enclosure is filled with a liquid. The system includes a cooling device positioned within the liquid within the enclosure. The system includes a sensor circuit located proximate to the first and second surfaces. The sensor circuit is configured to detect an amount of water condensate formed on the first and second surfaces in response to cooling of the first and second surfaces by the liquid cooled by the cooling device. The system includes a wiper in contact with each of the first and second surfaces. The wiper is configured to remove water condensate from the respective first and second surfaces when the sensor circuit detects the amount of water condensate formed on the respective first and second surfaces exceeds a predetermined value. The system includes a collector for collecting the water condensate removed from the first and second surfaces for use as potable water.

According to the first aspect, the first and second surfaces can comprise glass. Alternatively, the first and second surfaces can comprise metal, plastic or the like. The liquid can comprise water. Alternatively, the first and second surfaces can comprise alcohol or the like. Each of the first and second surfaces can be substantially rectangular. Alternatively, each of the first and second surfaces can be substantially circular, substantially planar or the like. The system can include a sterilizer for sterilizing the collected water condensate to produce the potable water. The system can include an atmosphere flow regulator for passing atmosphere over the first and second surfaces. The system can include a control circuit for controlling the atmosphere flow regulator to control a passage of atmosphere over the first and second surfaces. A volume of atmosphere passed over the first and second surfaces can be dependent upon a humidity of the atmosphere detected by the sensor circuit. The system can include a cooling fluid supplier for supplying a cooling fluid through the cooling device to cool the liquid within the enclosure. For example, the cooling fluid supplier can comprise a condenser. The cooling device can comprise a refrigeration coil. Alternatively, the cooling device can comprise a plurality of pipes, and a cooling fluid can be passed through each of the plurality of pipes to cool the liquid within the enclosure. The wiper can comprise a squeegee.

According to a second aspect of the present application, a system for producing potable water from atmosphere includes a plurality of surfaces arranged to form a sealed enclosure. The enclosure is substantially filled with a liquid. Each of the plurality of surfaces is comprised of a material on which water condensation from the atmosphere forms when there is a temperature differential between the material and the atmosphere. The system includes a cooling coil positioned within the liquid within the enclosure. The cooling coil is configured to cool the liquid within the enclosure to cool the plurality of surfaces. The system includes at least one humidity sensor located proximate to the plurality of surfaces. The at least one humidity sensor is configured to detect an amount of water condensate formed on the plurality of surfaces. The system includes a plurality of wipers. Each of the plurality of wipers is associated with a surface of the plurality of surfaces. Each of the plurality of wipers is configured to remove water condensate from each of the plurality of surfaces when the at least one humidity sensor detects the amount of water condensate formed on the plurality of surfaces exceeds a predetermined value. The system includes a collector for collecting the water condensate removed from the plurality of surfaces for use as potable water.

According to the second aspect, each of the plurality of surfaces can comprise glass. Alternatively, each of the plurality of surfaces can comprise metal, plastic or the like. The liquid can comprise water. Alternatively, the liquid can comprise alcohol or the like. Each of the plurality of surfaces can be substantially rectangular. Alternatively, each of the plurality of surfaces can be substantially circular, substantially planar, or the like. The system can include a sterilizer for sterilizing the collected water condensate to produce the potable water. The system can include an atmosphere flow regulator for passing atmosphere over the plurality of surfaces. The system can include a control circuit for controlling the atmosphere flow regulator to control a passage of atmosphere over the plurality of surfaces. A volume of atmosphere passed over the plurality of surfaces can be dependent upon a humidity of the atmosphere detected by the at least one humidity sensor. The system can include a cooling fluid supplier for supplying a cooling fluid through the cooling device to cool the liquid within the enclosure. For example, the cooling fluid supplier can comprise a condenser. The cooling device can comprise a refrigeration coil. Alternatively, the cooling device can comprise a plurality of pipes, and a cooling fluid can be passed through each of the plurality of pipes to cool the liquid within the enclosure. Each of the plurality of wipers can comprise a squeegee.

According to a third aspect of the present invention, a system for producing potable water from atmosphere includes a conduit. The conduit is comprised of a material on which water condensation from the atmosphere forms in response to a temperature differential between the material and the atmosphere. A cooling fluid is passed through the conduit to cool the conduit. The system includes a sensor circuit located proximate to a surface of the conduit. The sensor circuit is configured to detect an amount of water condensate formed on the surface of the conduit in response to cooling of the conduit by the cooling fluid. The system includes a wiper in circumferential contact with the surface of the conduit. The wiper is configured to remove water condensate from the surface of the conduit when the sensor circuit detects the amount of water condensate formed on the surface of the conduit exceeds a predetermined value. The system includes a collector for collecting the water condensate removed from the conduit for use as potable water.

According to the third aspect, the conduit can comprise glass. Alternatively, the conduit can comprise metal, plastic or the like. The cooling fluid can comprise a refrigerant. The conduit can comprise a coil. The system can include a sterilizer for sterilizing the collected water condensate to produce the potable water. The system can include an atmosphere flow regulator for passing atmosphere over the surface of the conduit. The system can include a control circuit for controlling the atmosphere flow regulator to control a passage of atmosphere over the surface of the conduit. A volume of atmosphere passed over the surface of the conduit is dependent upon a humidity of the atmosphere detected by the sensor circuit. The system can include a cooling fluid supplier for supplying the cooling fluid through the conduit. The cooling fluid supplier can comprise a condenser. The wiper can comprise a squeegee.

According to a fourth aspect of the present invention, a system for producing potable water from atmosphere includes a first surface, and a second surface arranged substantially parallel to the first surface. The first and second surfaces are comprised of a material on which water condensation from the atmosphere forms in response to a temperature differential between the material and the atmosphere. A seal is formed around a periphery of the first and second surfaces to form an enclosure between the first and second surfaces. The enclosure is filled with a liquid. The system includes means for cooling positioned within the liquid within the enclosure. The system includes sensing means for detecting an amount of water condensate formed on the first and second surfaces in response to cooling of the first and second surfaces by the liquid cooled by the means for cooling. The sensing means is located proximate to the first and second surfaces. The system includes means for removing water condensate from the respective first and second surfaces when the sensing means detects the amount of water condensate formed on the respective first and second surfaces exceeds a predetermined value. The means for removing is in contact with each of the first and second surfaces. The system includes means for collecting the water condensate removed from the first and second surfaces for use as potable water.

According to the fourth aspect, the first and second surfaces can comprise glass. Alternatively, the first and second surfaces can comprise metal, plastic or the like. The liquid can comprise water. Alternatively, the liquid can comprise alcohol or the like. Each of the first and second surfaces can be substantially rectangular. Alternatively, each of the first and second surfaces can be substantially circular, substantially planar, or the like. The system can include means for sterilizing the collected water condensate to produce the potable water. The system can include means for regulating a passage of atmosphere over the first and second surfaces. The system can include means for controlling the means for regulating to control the passage of atmosphere over the first and second surfaces. A volume of atmosphere passed over the first and second surfaces can be dependent upon a humidity of the atmosphere detected by the sensing means. The system can include means for supplying a cooling fluid through the means for cooling to cool the liquid within the enclosure. The means for supplying can comprise a condenser means. The means for cooling can comprise a refrigeration coil means. Alternatively, the means for cooling can comprise a plurality of conduit means. A cooling fluid can be passed through each of the plurality of conduit means to cool the liquid within the enclosure. The means for removing can comprise a wiper means.

According to a fifth aspect of the present invention, a system for producing potable water from atmosphere includes a plurality of surfaces arranged to form a sealed enclosure. The enclosure is substantially filled with a liquid. Each of the plurality of surfaces is comprised of a material on which water condensation from the atmosphere forms when there is a temperature differential between the material and the atmosphere. The system includes means for cooling positioned within the liquid within the enclosure. The means for cooling is configured to cool the liquid within the enclosure to cool the plurality of surfaces. The system includes at least one means for sensing humidity located proximate to each of the plurality of surfaces. The at least one means for sensing humidity is configured to detect an amount of water condensate formed on a respective one of the plurality of surfaces. The system includes a plurality of means for removing water condensate from each of the plurality of surfaces when the at least one means for sensing humidity detects the amount of water condensate formed on the plurality of surfaces exceeds a predetermined value. Each of the plurality of means for removing is associated with a surface of the plurality of surfaces. The system includes means for collecting the water condensate removed from the plurality of surfaces for use as potable water.

According to the fifth aspect, each of the plurality of surfaces can comprise glass. Alternatively, each of the plurality of surfaces can comprise metal, plastic or the like. The liquid can comprises water. Alternatively, the liquid can comprise alcohol or the like. Each of the plurality of surfaces can be substantially rectangular. Alternatively, each of the plurality of surfaces can be substantially circular, substantially planar or the like. The system can include means for sterilizing the collected water condensate to produce the potable water. The system can include means for regulating a passage of atmosphere over the plurality of surfaces. The system can include means for controlling the means for regulating to control the passage of atmosphere over the plurality of surfaces. A volume of atmosphere passed over the plurality of surfaces is dependent upon a humidity of the atmosphere detected by the at least one means for sensing humidity. The system can include means for supplying a cooling fluid through the means for cooling to cool the liquid within the enclosure. The means for supplying can comprise a condenser means. The means for cooling can comprise a refrigeration coil means. Alternatively, the means for cooling can comprise a plurality of conduit means. A cooling fluid can be passed through each of the plurality of conduit means to cool the liquid within the enclosure. Each of the plurality of means for removing can comprise a wiper means.

According to a sixth aspect of the present invention, a system for producing potable water from atmosphere includes a conduit means for conveying a cooling fluid for cooling the conduit means. The conduit means is comprised of a material on which water condensation from the atmosphere forms in response to a temperature differential between the material and the atmosphere. The system includes a sensor means for detecting an amount of water condensate formed on the surface of the conduit means in response to cooling of the conduit means by the cooling fluid. The sensor means is located proximate to a surface of the conduit means. The system includes means for removing water condensate from the surface of the conduit means when the sensor means detects the amount of water condensate formed on the surface of the conduit means exceeds a predetermined value. The means for removing is in circumferential contact with the surface of the conduit means. The system includes means for collecting the water condensate removed from the conduit means for use as potable water.

According to the sixth aspect, the conduit means can comprise glass. Alternatively, the conduit means can comprise metal, plastic or the like. The cooling fluid can comprise a refrigerant. The conduit means can comprise a coil. The system can include means for sterilizing the collected water condensate to produce the potable water. The system can include means for regulating a passage of atmosphere over the surface of the conduit means. The system can include means for controlling the means for regulating to control the passage of atmosphere over the surface of the conduit means. A volume of atmosphere passed over the surface of the conduit means is dependent upon a humidity of the atmosphere detected by the sensor means. The system can include means for supplying the cooling fluid conveyed through the conduit means. The means for supplying can comprise a condenser means. The means for removing can comprise a wiper means.

According to a seventh aspect of the present invention, a system for producing potable water from atmosphere includes a first surface on which water condensate from the atmosphere forms, and a second surface on which the water condensate from the atmosphere forms. The second surface is arranged substantially parallel to the first surface. A seal is formed around a periphery of the first and second surfaces to form an enclosure between the first and second surfaces. The enclosure is filled with a liquid. The system includes a cooling device positioned within the liquid within the enclosure. The water condensate forms on the first and second surfaces in response to cooling of the first and second surfaces by the liquid cooled by the cooling device. The system includes a wiper in contact with each of the first and second surfaces. The wiper is configured to remove water condensate from the respective first and second surfaces at predetermined intervals. The system includes a collector for collecting the water condensate removed from the first and second surfaces. The system includes a sterilizer for sterilizing the collected water condensate to produce potable water.

According to an eighth aspect of the present invention, a system for producing potable water from atmosphere includes a conduit on which water condensate from the atmosphere forms. A cooling fluid is passed through the pipe to cool the pipe. The water condensate forms on a surface of the pipe in response to cooling of the pipe by the cooling fluid. The system includes a wiper in circumferential contact with the surface of the pipe. The wiper is configured to remove water condensate from the surface of the pipe at predetermined intervals. The system includes a collector for collecting the water condensate removed from the surface of the conduit. The system includes a sterilizer for sterilizing the collected water condensate to produce potable water.

According to a ninth aspect of the present invention, a method of producing potable water from atmosphere includes the steps of: a.) enclosing a cooling device within a liquid within an enclosure, wherein surfaces of the enclosure are comprised of a material on which water condensation from the atmosphere forms in response to a temperature differential between the material and the atmosphere; b.) cooling the liquid in the enclosure to cool the surfaces of the enclosure; c.) detecting an amount of water condensate formed on the surfaces in response to cooling of the surfaces by the liquid cooled by the cooling device; d.) removing water condensate from the surfaces of the enclosure when the amount of water condensate formed on the surfaces exceeds a predetermined value; and e.) collecting the water condensate removed from the surfaces of the enclosure for use as potable water.

According to the ninth aspect, the surfaces of the enclosure can comprise glass. Alternatively, the surfaces of the enclosure can comprise metal, plastic or the like. The liquid can comprise water. Alternatively, the liquid can comprise alcohol or like. The surfaces of the enclosure can be substantially rectangular. Alternatively, the surfaces of the enclosure can be substantially circular, substantially planar or the like. The method can include the steps of: f.) sterilizing the collected water condensate to produce the potable water; g.) regulating a passage of atmosphere over the surfaces of the enclosure, wherein a volume of atmosphere passed over the surfaces of the enclosure is dependent upon a humidity of the atmosphere; and h.) conveying a cooling fluid through the cooling device to cool the liquid within the enclosure.

According to a tenth aspect of the present invention, a method for producing potable water from atmosphere, comprising: a.) conveying a cooling fluid through a conduit to cool the conduit, wherein the conduit is comprised of a material on which water condensation from the atmosphere forms in response to a temperature differential between the material and the atmosphere; b.) detecting an amount of water condensate formed on a surface of the conduit in response to cooling of the conduit by the cooling fluid; c.) removing water condensate from the surface of the conduit when the amount of water condensate formed on the surface of the conduit exceeds a predetermined value; and d.) collecting the water condensate removed from the conduit for use as potable water.

According to the tenth aspect, the conduit can comprise glass. Alternatively, the conduit can comprise metal, plastic or the like. The cooling fluid can comprise a refrigerant. The conduit can comprise a coil. The method can include the steps of: e.) sterilizing the collected water condensate to produce the potable water; and f.) regulating a passage of atmosphere over the surface of the conduit, wherein a volume of atmosphere passed over the surface of the conduit is dependent upon a humidity of the atmosphere.

According to an eleventh aspect of the present invention, a system for producing potable water from atmosphere includes a plurality of surfaces arranged to form a sealed enclosure. Each of the plurality of surfaces is comprised of a material on which water condensation from the atmosphere forms when there is a temperature differential between the material and the atmosphere. The system includes a cooling fluid supplier in fluid communication with the sealed enclosure for supplying a cooling fluid within the sealed enclosure. The system includes at least one humidity sensor located proximate to the plurality of surfaces. The at least one humidity sensor is configured to detect an amount of water condensate formed on the plurality of surfaces. The system includes a plurality of wipers. Each of the plurality of wipers is associated with a surface of the plurality of surfaces. Each of the plurality of wipers is configured to remove water condensate from each of the plurality of surfaces when the at least one humidity sensor detects the amount of water condensate formed on the plurality of surfaces exceeds a predetermined value. The system includes a collector for collecting the water condensate removed from the plurality of surfaces for use as potable water.

According to the eleventh aspect, each of the plurality of surfaces can comprise glass, metal, plastic or other suitable material. The cooling fluid can comprise water, alcohol or other suitable cooling fluid. Each of the plurality of surfaces can substantially rectangular, substantially circular, substantially planar or other suitable configuration. The system can include a sterilizer for sterilizing the collected water condensate to produce the potable water. The system can include an atmosphere flow regulator for passing atmosphere over the plurality of surfaces. The system can include a control circuit for controlling the atmosphere flow regulator to control a passage of atmosphere over the plurality of surfaces. A volume of atmosphere passed over the plurality of surfaces can be dependent upon a humidity of the atmosphere detected by the at least one humidity sensor. The cooling fluid supplier can comprise a condenser or other suitable device. Each of the plurality of wipers can comprise a squeegee.

According to a twelfth aspect of the present invention, a system for producing potable water from atmosphere includes an enclosure. The enclosure includes at least one sealable intake port, and at least one sealable exhaust port. The system includes a plurality of panels arranged within the enclosure substantially parallel to each other along a central axis. Each of the plurality of panels is composed of a material on which water condensate from the atmosphere forms in response to a temperature differential between the material and the atmosphere passed through the enclosure. The system includes a plurality of conduits arranged to pass through the plurality of panels. A cooling fluid is passed through the plurality of conduits to cool the plurality of panels. An amount of the water condensate formed on surfaces of the plurality of panels in response to cooling is detected. The plurality of panels are configured to be rotated about the central axis within the enclosure to remove the water condensate from the surfaces of the plurality of panels when the detected amount of the water condensate exceeds a predetermined threshold.

According to the twelfth aspect, the system can include a sensor circuit located proximate to the plurality of panels. The sensor circuit is configured to detect the amount of the water condensate formed on the surfaces of the plurality of panels in response to cooling. The system can include an atmosphere flow regulator. The atmosphere flow regulator is configured to pass the atmosphere through the at least one sealable intake port into the enclosure and over the surfaces of the plurality of panels. The system can include a control circuit in communication with the atmosphere flow regulator. The control circuit is configured to control the atmosphere flow regulator to control a passage of the atmosphere over the surfaces of the plurality of panels. A volume of atmosphere passed over the surfaces of the plurality of panels is dependent upon a humidity of the atmosphere detected by the sensor circuit. The plurality of conduits can penetrate the plurality of panels substantially perpendicular to the plurality of panels. The plurality of conduits can be arranged substantially parallel to the central axis.

According to the twelfth aspect, each of the plurality of panels can be separated from an adjacent panel by a predetermined distance. Each of the plurality of conduits is separated from an adjacent conduit by a predetermined distance. Each of the plurality of panels can comprise metal, such as, for example, aluminum. Each of the plurality of conduits can comprise metal. The cooling fluid can comprise, for example, water. The enclosure can be substantially cylindrical. Each of the plurality of panels can be substantially circular. Alternatively, each of the plurality of panels can comprise two pairs of opposing edges. For example, a first pair of opposing edges can be curved, and a second pair of opposing edges can be substantially straight. The plurality of conduits can be in fluid communication with each other.

The system can include an atmosphere filtration device. The atmosphere filtration device can be configured to filter the atmosphere passed into the enclosure via the at least one sealable intake port. The system can include a collector. The collector can be configured to hold collected water condensate removed from the surfaces of the plurality of panels that is passed out of the at least one sealable exhaust port, after rotation of the enclosure. The system can include a sterilizer. The sterilizer can be configured to sterilize the collected water condensate to produce the potable water. The system can include a cooling fluid supplier. The cooling fluid supplier can be configured to supply the cooling fluid through the plurality of conduits to cool the plurality of panels. The cooling fluid supplier can comprise, for example, a condenser. The plurality of conduits can comprise a plurality of pipes. The cooling fluid can be passed through each of the plurality of pipes to cool the plurality of panels.

According to the twelfth aspect, the enclosure can comprise, for example, a radiator. Each of the plurality of panels can comprise a fin of the radiator. The system can include a rotation device in connection with the central axis. The rotation device can be configured to turn the central axis to rotate the plurality of panels within the enclosure. The system can include an enclosure support configured to support the enclosure. The central axis can comprise a supply conduit. The supply conduit can be in fluid communication with the plurality of conduits. The cooling fluid can enter the enclosure through a first end of the supply conduit to be passed through the plurality of conduits. The cooling fluid can exit the enclosure from the plurality of conduits through a second end of the supply conduit.

According to a thirteenth aspect of the present invention, a system for producing potable water from atmosphere includes means for enclosing a space. The space enclosing means includes at least one sealable intake port means, and at least one sealable exhaust port means. The system includes a plurality of means for forming water condensate arranged within the space enclosing means substantially parallel to each other along a central axis. Each of the plurality of water condensate forming means is comprised of a material on which water condensate from the atmosphere forms in response to a temperature differential between the material and the atmosphere passed through the space enclosing means. The system includes a plurality of means for passing cooling fluid through the plurality of water condensate forming means to cool the plurality of water condensate forming means. An amount of the water condensate formed on surfaces of the plurality of water condensate forming means in response to cooling is detected. The plurality of water condensate forming means are configured to be rotated about the central axis within the space enclosing means to remove the water condensate from the surfaces of the plurality of water condensate forming means when the detected amount of the water condensate exceeds a predetermined threshold.

According to the thirteenth aspect, the system can include means for sensing humidity located proximate to the plurality of water condensate forming means. The humidity sensing means can be configured to detect the amount of the water condensate formed on the surfaces of the plurality of water condensate forming means in response to cooling. The system can include means for regulating atmosphere flow. The atmosphere flow regulating means can be configured to pass the atmosphere through the at least one sealable intake port means into the space enclosing means and over the surfaces of the plurality of water condensate forming means. The system can include means for controlling the atmosphere flow regulating means. The controlling means can be configured to control the atmosphere flow regulating means to control a passage of the atmosphere over the surfaces of the plurality of water condensate forming means. A volume of atmosphere passed over the surfaces of the plurality of water condensate forming means can be dependent upon a humidity of the atmosphere detected by the humidity sensing means. The plurality of cooling fluid passing means can penetrate the plurality of water condensate forming means substantially perpendicular to the plurality of water condensate forming means. The plurality of cooling fluid passing means can be arranged substantially parallel to the central axis.

According to the thirteenth aspect, each of the plurality of water condensate forming means can be separated from an adjacent water condensate forming means by a predetermined distance. Each of the plurality of cooling fluid passing means can be separated from an adjacent cooling fluid passing means by a predetermined distance. Each of the plurality of water condensate forming means can comprise metal, such as, for example, aluminum. Each of the plurality of cooling fluid passing means can comprise metal. The cooling fluid can comprise, for example, water. The space enclosing means can be substantially cylindrical. Each of the plurality of water condensate forming means can be substantially circular. Alternatively, each of the plurality of water condensate forming means can comprise two pairs of opposing edges. For example, a first pair of opposing edges can be curved, and a second pair of opposing edges can be substantially straight. The plurality of cooling fluid passing means can be in fluid communication with each other.

According to the thirteenth aspect, the system can include means for filtering atmosphere. The atmosphere filtering means can be configured to filter the atmosphere passed into the space enclosing means via the at least one sealable intake port means. The system can include means for collecting water condensate. The water condensate collecting means can be configured to hold collected water condensate removed from the surfaces of the plurality of water condensate forming means that is passed out of the at least one sealable exhaust port means, after rotation of the space enclosing means. The system can include means for sterilizing water condensate. The water condensate sterilizing means can be configured to sterilize the collected water condensate to produce the potable water. The system can include means for supplying cooling fluid. The cooling fluid supplying means can be configured to supply the cooling fluid through the plurality of cooling fluid passing means to cool the plurality of water condensate forming means. The cooling fluid supplying means can comprise, for example, a condenser means. The plurality of cooling fluid passing means can comprise a plurality of conduit means. The cooling fluid can be passed through each of the plurality of conduit means to cool the plurality of water condensate forming means.

According to the thirteenth aspect, the space enclosing means can comprise a radiator means. For example, each of the plurality of water condensate forming means can comprise a fin of the radiator means. The system can include means for rotating the plurality of water condensate forming means in connection with the central axis. The rotating means can be configured to turn the central axis to rotate the plurality of water condensate forming means within the space enclosing means. The system can include means for supporting the space enclosing means. The central axis can comprise a supply means. The supply means can be in fluid communication with the plurality of cooling fluid passing means. The cooling fluid can enter the space enclosing means through a first end of the supply means to be passed through the plurality of cooling fluid passing means. The cooling fluid can exit the space enclosing means from the plurality of cooling fluid passing means through a second end of the supply means.

According to a fourteenth aspect of the present invention, a method of producing potable water from atmosphere, comprising the steps of: a.) cooling a plurality of panels arranged within an enclosure substantially parallel to each other along a central axis, wherein each of the plurality of panels is comprised of a material on which water condensate from the atmosphere forms in response to a temperature differential between the material and the atmosphere passed through the enclosure; b.) passing atmosphere through the enclosure and over surfaces of the plurality of panels to form the water condensate on surfaces of the plurality of panels; c.) detecting an amount of the water condensate formed on the surfaces of the plurality of panels in response to cooling; d.) determining whether the amount of the water condensate formed on the surfaces of the plurality of panels exceeds a predetermined threshold; and e.) rotating the plurality of panels about the central axis within the enclosure to remove the water condensate from the surfaces of the plurality of panels, when the amount of the water condensate formed on the surfaces of the plurality of panels exceeds the predetermined threshold.

According to the fourteenth aspect, the method can include the steps of: f.) detecting a humidity of the atmosphere; and g.) controlling an amount of atmosphere passed through the enclosure and over the plurality of panels based upon the humidity of the atmosphere detected in step (f). Each of the plurality of panels can be separated from an adjacent panel by a predetermined distance. Each of the plurality of panels can comprise metal, such as, for example, aluminum. The method can include the steps of: h.) filtering the atmosphere passed into the enclosure and over the plurality of panels; i.) collecting the water condensate removed from the surfaces of the plurality of panels; j.) sterilizing the collected water condensate to produce the potable water; and k.) supplying a cooling fluid into the enclosure to cool the plurality of panels.

According to a fifteenth aspect of the present invention, a system for producing potable water from atmosphere includes a sealed enclosure. The sealed enclosure includes at least one sealable air intake port through which atmosphere is passed into the sealed enclosure, and at least one sealable potable water exhaust port through which collected potable water is passed out of the sealed enclosure. The system includes a plurality of panels arranged within the sealed enclosure substantially parallel to each other and substantially perpendicular to a central axis. Each of the plurality of panels is comprised of a material on which water condensate from the atmosphere forms in response to a temperature differential between the material and the atmosphere passed through the enclosure. Each of the plurality of panels is separated from an adjacent panel by a first predetermined distance. The system includes a plurality of conduits penetrating the plurality of panels and arranged substantially perpendicular to the plurality of panels and substantially parallel to the central axis. Each of the plurality of conduits is separated from an adjacent conduit by a second predetermined distance. A cooling fluid is passed through the plurality of conduits to cool the plurality of panels. The system includes a sensor circuit located proximate to the plurality of panels. The sensor circuit is configured to detect an amount of water condensate formed on surfaces of the plurality of panels in response to cooling of the plurality of panels. The plurality of panels are configured to be rotated about the central axis within the sealed enclosure to remove the water condensate from the surfaces of the plurality of panels when the detected amount of water condensate exceeds a predetermined threshold.

According to a sixteenth aspect of the present invention, a system for producing potable water from atmosphere includes an enclosure. The enclosure includes an intake port, and an exhaust port. The system includes a plurality of cooling surfaces arranged within the enclosure about a central axis. The plurality of cooling surfaces are comprised of a material on which water condensate from the atmosphere forms in response to a temperature differential between the material and the atmosphere passed through the enclosure. The system includes a plurality of conduits arranged within the enclosure. The plurality of conduits are arranged to pass through the plurality of cooling surfaces. A cooling fluid is passed through the plurality of conduits to cool the plurality of cooling surfaces. An amount of the water condensate formed on the plurality of cooling surfaces in response to cooling is detected. The plurality of cooling surfaces are configured to be rotated about the central axis within the enclosure to remove the water condensate from the plurality of cooling surfaces when the detected amount of the water condensate exceeds a predetermined threshold.

According to the sixteenth aspect, he plurality of cooling surfaces can comprise interlacing meshes of cooling strands. Each of the cooling strands can comprise metal, such as, for example, aluminum. The system can include a sensor circuit located proximate to the plurality of cooling surfaces. The sensor circuit can be configured to detect the amount of the water condensate formed on the plurality of cooling surfaces in response to cooling.

### BRIEF DESCRIPTION OF THE DRAWINGS

Other objects and advantages of the present invention will become apparent to those skilled in the art upon reading the following detailed description of preferred embodiments, in conjunction with the accompanying drawings, wherein like reference numerals have been used to designate like elements, and wherein:

FIG. 1 is a diagram illustrating a system for producing potable water from atmosphere, in accordance with an exemplary embodiment of the present invention.

FIG. 2 is a diagram illustrating a system for producing potable water from atmosphere, in accordance with an alternative exemplary embodiment of the present invention.

FIG. 3 is a flowchart illustrating steps for producing potable water from atmosphere, in accordance with an exemplary embodiment of the present invention.

FIG. 4 is a flowchart illustrating steps for producing potable water from atmosphere, in accordance with an alternative exemplary embodiment of the present invention.

FIG. 5 is a diagram illustrating a system for producing potable water from atmosphere, in accordance with an alternative exemplary embodiment of the present invention.

FIG. 6 is a diagram illustrating a system for producing potable water from atmosphere, in accordance with an alternative exemplary embodiment of the present invention.

FIG. 7 is a diagram illustrating a plurality of panels used for producing potable water from atmosphere, in accordance with the alternative exemplary embodiment of the present invention.

FIG. 8 is a diagram illustrating an angled view of the system for producing potable water from atmosphere, in accordance with an alternative exemplary embodiment of the present invention.

FIG. 9 is a diagram illustrating a cut-away side view of the system for producing potable water from atmosphere, in accordance with an alternative exemplary embodiment of the present invention.

FIG. 10 is a flowchart illustrating steps for producing potable water from atmosphere, in accordance with an alternative exemplary embodiment of the present invention.

### DETAILED DESCRIPTION OF THE PREFERRED EMBODIMENTS

Exemplary embodiments of the present invention are directed to a system and method for extracting potable water from the atmosphere. According to exemplary embodiments, the system can include a first surface, and a second surface arranged substantially parallel to the first surface. The first and second surfaces can be comprised of a material, such as, for example, glass, metal, plastic or the like, on which water condensation from the atmosphere can form in response to a temperature differential between the material and the atmosphere. A seal can be formed around the periphery of the first and second surfaces to form an enclosure between the first and second surfaces. The enclosure can be filled with a liquid, such as, for example, water, alcohol or the like, and a cooling device, such as, for example, a refrigeration coil, can be positioned within the liquid within the enclosure. A sensor circuit located proximate to the first and second surfaces can detect the amount of water condensate formed on the first and second surfaces in response to the cooling of the surfaces by the liquid that is cooled by the cooling device. A wiper, such as a squeegee or the like, in contact with each of the first and second surfaces can remove water condensate from the respective first and second surfaces when the sensor circuit detects the amount of water condensate formed on the respective first and second surfaces exceeds a predetermined value. A collector can collect the water condensate removed from the first and second surfaces for use as potable water. In addition, the collector can include a sterilizer for sterilizing the collected water condensate to produce the potable water. Furthermore, a control circuit connected to an atmosphere flow regulator can control the volume of atmosphere passed over the first and second surfaces to vary the amount of condensate formed on the surfaces to increase or decrease the amount of potable water produced by the system.

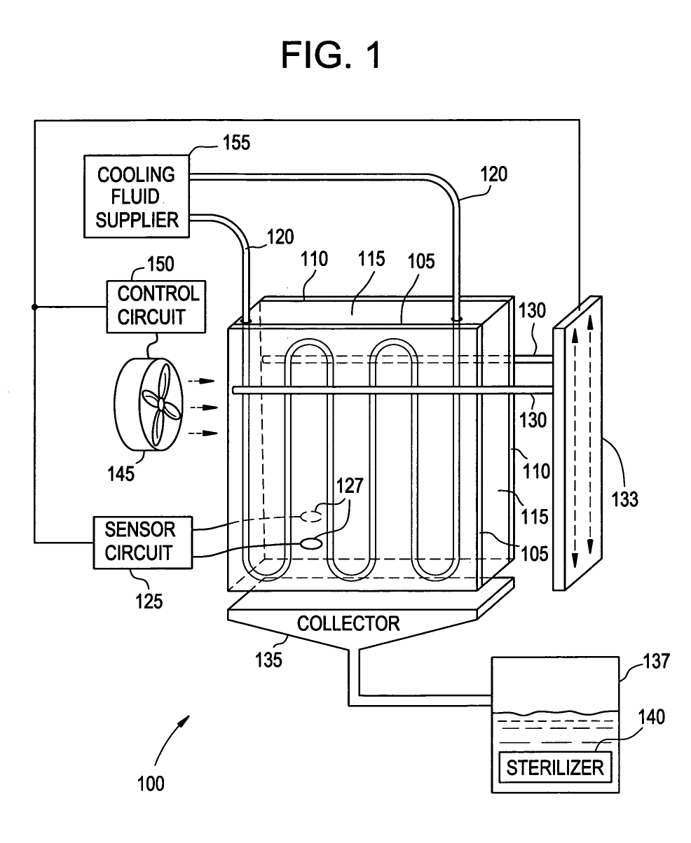

These and other aspects of the present invention will now be described in greater detail. FIG. 1 is a diagram illustrating a system 100 for producing potable water from atmosphere, in accordance with an exemplary embodiment of the present invention. The system 100 includes a first surface 105 and a second surface 110. The second surface 110 can be arranged substantially parallel to the first surface 105. The first and second surfaces 105 and 110 can be comprised of a material on which water condensation from the atmosphere forms in response to a temperature differential between the material and the atmosphere. The material can be any suitable material on which water condensation can form in response to cooling of the material in a humid environment. For example, the material can be comprised of glass, metal, plastic or the like.

A seal 115 is formed around a periphery of the first and second surfaces 105 and 110 to form an enclosure between the first and second surfaces 105 and 110. The seal 115 can be comprised of the same material as the first and second surfaces 105 and 110, although the seal 115 can be comprised of any suitable material to form the enclosure. According to exemplary embodiments, the first and second surfaces 105 and 110 can be spaced apart from each other by any suitable distance to create an enclosure of any desired volume. According to one exemplary embodiment, the first and second surfaces 105 and 110 can be spaced apart by approximately one inch, although any suitable spacing distance can be used. According to exemplary embodiments, the enclosure is substantially completely filled with a liquid. Any suitable liquid can be used to substantially completely fill the enclosure, including water, alcohol, an appropriate gas in a liquid state or the like.

The system 100 includes a cooling device 120 positioned within the enclosure. The cooling device 120 can be comprised of any suitable mechanism capable of cooling the liquid within the enclosure. For example, the cooling device 120 can comprise a refrigeration coil. According to an alternatively exemplary embodiment, the cooling device 120 can comprise a plurality of pipes, in which a cooling fluid can be passed through each of the plurality of pipes to cool the liquid within the enclosure. Other such mechanisms and configurations can be used for the cooling device 120. The system 100 can include a cooling fluid supplier 155 connected to the cooling device 120 for supplying a cooling fluid through the cooling device 120 to cool the liquid within the enclosure. The cooling fluid supplier 155 can be, for example, a condenser or other suitable refrigeration device capable of providing the cooling fluid (e.g., freon, a freon substitute, water or the like fluid) through the cooling device 120. According to exemplary embodiments, the cooling device 120 is immersed in the liquid in the enclosure to more evenly distribute the cooling of the first and second surfaces 105 and 110, thereby allowing for more even water condensation across the entirety of first and second surfaces 105 and 110. Thus, the cooling device 120 cools the liquid in the enclosure, which, in turn, substantially evenly cools the first and second surfaces 105 and 110.

The system 100 includes a sensor circuit 125 located proximate to the first and second surfaces 105 and 110. The sensor circuit 125 is configured to detect the amount of water condensate formed on the first and second surfaces 105 and 110 in response to cooling of the first and second surfaces 105 and 110 by the liquid that is cooled by the cooling device 120. The sensor circuit 125 can comprise, for example, a humidity sensor or other suitable type of electrical or electronic sensor or circuit that is capable of detecting the presence and amount of water formed on a surface. The sensor circuit 125 can include, for example, a plurality of sensor pads 127 that rest on or near each of the first and second surfaces 105 and 110 and are in electrical communication with the sensor circuit 125. Any appropriate number of sensor pads 127 can be placed in any suitable locations over the first and second surfaces 105 and 110 to allow for a proper determination of the amount of water condensate formed on the surfaces.

The system 100 includes a wiper 130 in contact with each of the first and second surfaces 105 and 110. The wipers 130 can comprise a squeegee or any other suitable type of component capable of removing water from a surface, such as a brush or the like. Each of the wipers 130 is configured to remove water condensate from the respective first and second surfaces 105 and 110 when the sensor circuit 125 detects the amount of water condensate formed on the respective first and second surfaces 105 and 110 exceeds a predetermined value. The system 100 can include a wiper movement mechanism 133 that is configured to move the wipers 130 across each of the first and second surfaces 105 and 110. For example, the wipers 130 can be initially positioned at the top of the first and second surfaces 105 and 110 and wipe the surfaces in a downward direction to remove the water condensate, and then return to their respective initial positions. The wiper movement mechanism 133 can be in electrical communication with the sensor circuit 125 using any suitable type of electrical connection. The wiper movement mechanism 133 can be comprised of any suitable electrical, electronic and/or mechanical means capable of moving the wipers 130.

According to exemplary embodiments, when the sensor circuit 125 determines that the amount of water condensate formed on a surface exceeds the predetermined threshold, the sensor circuit 125 can activate the wiper movement mechanism 133 to move the appropriate wiper across the given surface (e.g., either or both wipers 130 across either or both of first and second surfaces 105 and 110). The predetermined threshold of water condensate can be based on such factors as the size of the first and second surfaces 105 and 110, the amount or rate at which water is desired to be produced, the relative humidity of the atmosphere and other similar factors. According to an exemplary embodiment, the sensor circuit 125 can be configured to adapt the predetermined threshold to accommodate changing conditions (e.g., lower the predetermined threshold if the relative humidity or the desired rate of water production increases). Thus, water condensate can be removed from each of the first and second surfaces 105 and 110 independently (e.g., based on the amount of water formed on each surface) or concurrently (e.g., a predetermined threshold reached on one surface activates wiping of both surfaces). According to an alternative exemplary embodiment, the predetermined threshold can be a timing interval to activate wiping of the first and second surfaces 105 and 110 either independently or concurrently at predetermined intervals.

The system 100 includes a collector 135 for collecting the water condensate removed from the first and second surfaces 105 and 110 for use as potable water. The collector 135 can be any suitable form of trap, basin, drain or the like that is capable of capturing or otherwise collecting and temporarily storing the water condensate removed from the first and second surfaces 105 and 110. The collector 135 can be located below the first and second surfaces 105 and 110 to capture the falling water condensate as it is removed from the surfaces by the wipers 130. The collector 135 can include a tank 137 for storing the collected water condensate. The collector 135 can include a sterilizer 140 for sterilizing the collected water condensate to produce the potable water. The sterilizer 140 can be located, for example, in or near the tank 137. The sterilizer 140 can be any suitable device capable of sterilizing water, such as, for example, any suitable chemical means (e.g., chlorine), a heating element (e.g., to boil the water), an ultraviolet radiation emitter, or the like.

The system 100 can include an atmosphere flow regulator 145 for passing atmosphere over the first and second surfaces 105 and 110. The atmosphere flow regulator 145 can be any suitable type of electrical, electronic or mechanical means capable of moving air over the first and second surfaces 105 and 110, such as, for example, a fan, a blower, or the like. The system 100 can also include a control circuit 150 for controlling the atmosphere flow regulator 145 to control the passage of atmosphere over the first and second surfaces 105 and 110. The control circuit 150 can be comprised of any suitable digital, analog, or mechanical means that is capable of controlling the rate of air flow produced by the atmosphere flow regulator 145. According to exemplary embodiments, the volume of atmosphere passed over the first and second surfaces 105 and 110 can be dependent upon, for example, the humidity of the atmosphere detected by the sensor circuit 125 (e.g., the volume of atmosphere passed over the surfaces can increase as the relative humidity decreases and vice versa).

For example, the control circuit 150 can be in electrical communication with the sensor circuit 125 using any suitable form of electrical connection. If the sensor circuit 125 detects that, for example, the rate of water condensation on the first and second surfaces 105 and 110 is decreasing (e.g., the interval between wiper activations is increasing) or the rate of water production is below a desired rate or threshold (e.g., the relative humidity of the atmosphere is decreasing), the sensor circuit 125 can send an electrical signal or command to the control circuit 150 to increase the rate of air flow from the atmosphere flow regulator 145. Alternatively, if the sensor circuit 125 detects that, for example, the rate of water condensation on the first and second surfaces 105 and 110 is increasing (e.g., the interval between wiper activations is decreasing) or the rate of water production is above a desired rate or threshold (e.g., the relative humidity of the atmosphere is increasing), the sensor circuit 125 can send an electrical signal or command to the control circuit 150 to decrease the rate of air flow from the atmosphere flow regulator 145 to maintain a steady or substantially constant production of potable water.

According to exemplary embodiments, the first and second surfaces 105 and 110 can be of any suitable configuration. For example, the size of the first and second surfaces 105 and 110 can depend on the desired amount of water production. Additionally, the first and second surfaces 105 and 110 can be substantially rectangular, substantially circular, substantially planar or the like.

Other alternative configurations of system 100 illustrated in FIG. 1 can be used. For example, the system 100 can include a plurality of surfaces arranged to form a sealed enclosure. The enclosure can be substantially filled with a liquid. Each of the plurality of surfaces can be comprised of a material on which water condensation from the atmosphere forms when there is a temperature differential between the material and the atmosphere. The system 100 can include a cooling coil (e.g., cooling device 120) positioned within the liquid within the enclosure. The cooling coil can be configured to cool the liquid within the enclosure to cool the plurality of surfaces. The system 100 can include at least one humidity sensor (e.g., sensor circuit 125) located proximate to the plurality of surfaces. Each of the at least one humidity sensor can be configured to detect an amount of water condensate formed on the plurality of surfaces. The system 100 can include a plurality of wipers (e.g., wipers 130). Each of the plurality of wipers can be associated with a surface of the plurality of surfaces. Each of the plurality of wipers can be configured to remove water condensate from each of the plurality of surfaces when the at least one humidity sensor detects the amount of water condensate formed on the plurality of surfaces exceeds a predetermined value. The system 100 can include a collector (e.g., collector 135) for collecting the water condensate removed from the plurality of surfaces for use as potable water. Thus, alternative exemplary embodiments of the present invention can form a rectangle, pentagon, octagon or other like enclosed structure in which water condensate can be removed from each side of the structure.

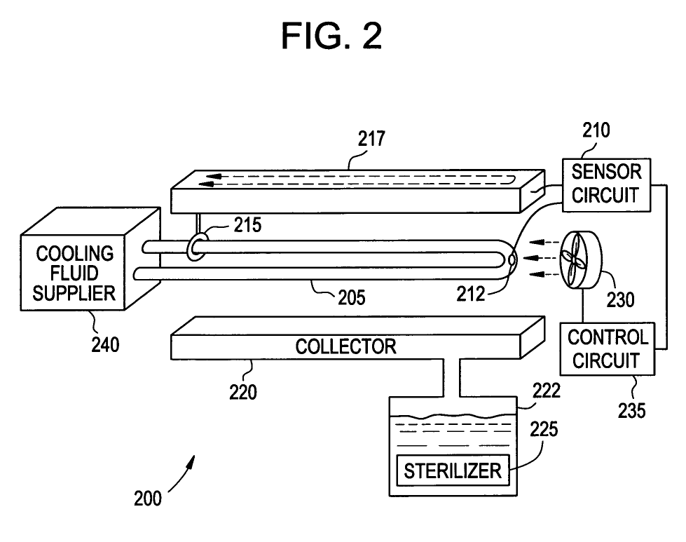

Alternatively, for example, FIG. 2 is a diagram illustrating a system 200 for producing potable water from atmosphere, in accordance with an alternative exemplary embodiment of the present invention. The system 200 includes a conduit 205. The conduit 205 is comprised of a material on which water condensation from the atmosphere forms in response to a temperature differential between the material and the atmosphere. The material can be any suitable material on which water condensation can form in response to cooling of the material in a humid environment. For example, the material can be comprised of glass, metal, plastic or the like. The conduit 205 can be of any suitable configuration, such as, for example, a coil, a single tube or pipe, a plurality of tubes or pipes, and the like. The conduit 205 can be of any suitable length and diameter, depending on the desired amount of water production.

According to exemplary embodiments, a cooling fluid is passed through the conduit 205 to cool the conduit 205 so that water condensate can form on the surface of the conduit 205. The cooling fluid can be comprised of any suitable refrigerant capable of cooling the surface of the conduit 205, including, for example, freon, a freon substitute, water, alcohol or other like cooling fluid. The system can include a cooling fluid supplier 240 for supplying the cooling fluid through the conduit 205. The cooling fluid supplier 240 can be, for example, a condenser or other suitable refrigeration device capable of providing the cooling fluid through the conduit 205.

The system 200 includes a sensor circuit 210 located proximate to the surface of the conduit 205. The sensor circuit 210 is configured to detect the amount of water condensate formed on the surface of the conduit 205 in response to cooling of the conduit 205 by the cooling fluid. The sensor circuit 210 can comprise, for example, a humidity sensor or other suitable type of electrical or electronic sensor or circuit that is capable of detecting the presence and amount of water formed on the surface of the conduit 205. The sensor circuit 210 can include, for example, a plurality of sensor pads 212 that rest on or near the surface of conduit 205 and are in electrical communication with the sensor circuit 210. Any appropriate number of sensor pads 212 can be placed in any suitable locations over the surface of the conduit 205 to allow for a proper determination of the amount of water condensate formed on the conduit 205.

The system 200 includes a wiper 215 in circumferential contact with the surface of the conduit 205. The wiper 215 is configured to remove water condensate from the surface of the conduit 205 when the sensor circuit 210 detects the amount of water condensate formed on the surface of the conduit 205 exceeds a predetermined value. For example, the wiper 215 can be in the form of a ring or donut shape. The wiper 215 can comprise a squeegee or any other suitable type of component capable of removing water from a surface, such as a brush or the like. The system 200 can include a wiper movement mechanism 217 that is configured to move the wiper 215 across the conduit 205. For example, the wiper 215 can be initially positioned at one end of the conduit 205 (starting near the cooling fluid supplier 240) and wipe the surface to the other end of the conduit 205 (ending near the cooling fluid supplier 240). The wiper 215 can then be returned to its original position either at that time or when another wiping of the conduit 205 occurs (e.g., creating a back and forth movement along the conduit 205).

However, any suitable number of wipers 215 can be used to wipe conduit 205. For example, two wipers 205 can be used to wipe the conduit 205, one at each end of the conduit 205 (both starting, e.g., near the cooling fluid supplier 240). Each wiper 205 can wipe a length of the conduit 205 and then return to its respective original position (e.g., near the cooling fluid supplier 240) either at that time or when another wiping of the conduit 205 occurs (e.g., creating a back and forth movement along the conduit 205). The wiper movement mechanism 217 can be in electrical communication with the sensor circuit 210 using any suitable type of electrical connection. The wiper movement mechanism 217 can be comprised of any suitable electrical, electronic and/or mechanical means capable of moving the wiper 215.

According to exemplary embodiments, when the sensor circuit 210 determines that the amount of water condensate formed on the surface of the conduit 205 exceeds the predetermined threshold, the sensor circuit 210 can activate the wiper movement mechanism 217 to move the wiper 215 across the conduit 205. The predetermined threshold will be based on factors such as the size and length of the conduit 205, the amount or rate at which water is desired to be produced, the relative humidity of the atmosphere and other similar factors. According to an exemplary embodiment, the sensor circuit 210 can be configured to adapt the predetermined threshold to accommodate changing conditions (e.g., lower the predetermined threshold if the relative humidity or the desired rate of water production increases). According to an alternative exemplary embodiment, the predetermined threshold can be a timing interval to activate wiping of the conduit 205 at predetermined intervals.

The system 200 includes a collector 220 for collecting the water condensate removed from the conduit 205 for use as potable water. The collector 220 can be any suitable form of trap, basin or the like that is capable of capturing or otherwise collecting and temporarily storing the water condensate removed from the conduit 205. The collector 220 can be located underneath the conduit 205 to capture the falling water condensate as it is removed from the conduit 205 by the wiper 215. The collector 220 can include a tank 222 for storing the collected water condensate. The collector 220 can include a sterilizer 225 for sterilizing the collected water condensate to produce the potable water. The sterilizer 225 can be located, for example, in the tank 222. The sterilizer 225 can be any suitable device capable of sterilizing water, such as, for example, any suitable chemical means, a heating element (e.g., to boil the water), an ultraviolet radiation emitter, or the like.

The system 200 can include an atmosphere flow regulator 230 for passing atmosphere over the surface of the conduit 205. The atmosphere flow regulator 230 can be any suitable type of electrical, electronic or mechanical means capable of moving air over the conduit 205, such as, for example, a fan, a blower, or the like. The system 200 can also include a control circuit 235 for controlling the atmosphere flow regulator 230 to control a passage of atmosphere over the surface of the conduit 205. The control circuit 235 can be comprised of any suitable digital, analog, or mechanical means that is capable of controlling the rate of air flow produced by the atmosphere flow regulator 235. According to exemplary embodiments, the volume of atmosphere passed over the conduit 205 can be dependent upon, for example, the humidity of the atmosphere detected by the sensor circuit 210.

For example, the control circuit 235 can be in electrical communication with the sensor circuit 210 using any suitable form of electrical connection. If the sensor circuit 210 detects that, for example, the rate of water condensation on the conduit 205 is decreasing (e.g., the interval between wiper activations is increasing) or the rate of water production is below a desired rate or threshold (e.g., the relative humidity of the atmosphere is decreasing), the sensor circuit 210 can send an electrical signal or command to the control circuit 235 to increase the rate of air flow from the atmosphere flow regulator 230. Alternatively, if the sensor circuit 210 detects that, for example, the rate of water condensation on the conduit 205 is increasing (e.g., the interval between wiper activations is decreasing) or the rate of water production is above a desired rate or threshold (e.g., the relative humidity of the atmosphere is increasing), the sensor circuit 210 can send an electrical signal or command to the control circuit 235 to decrease the rate of air flow from the atmosphere flow regulator 230 in order to maintain a steady or substantially constant production of potable water.

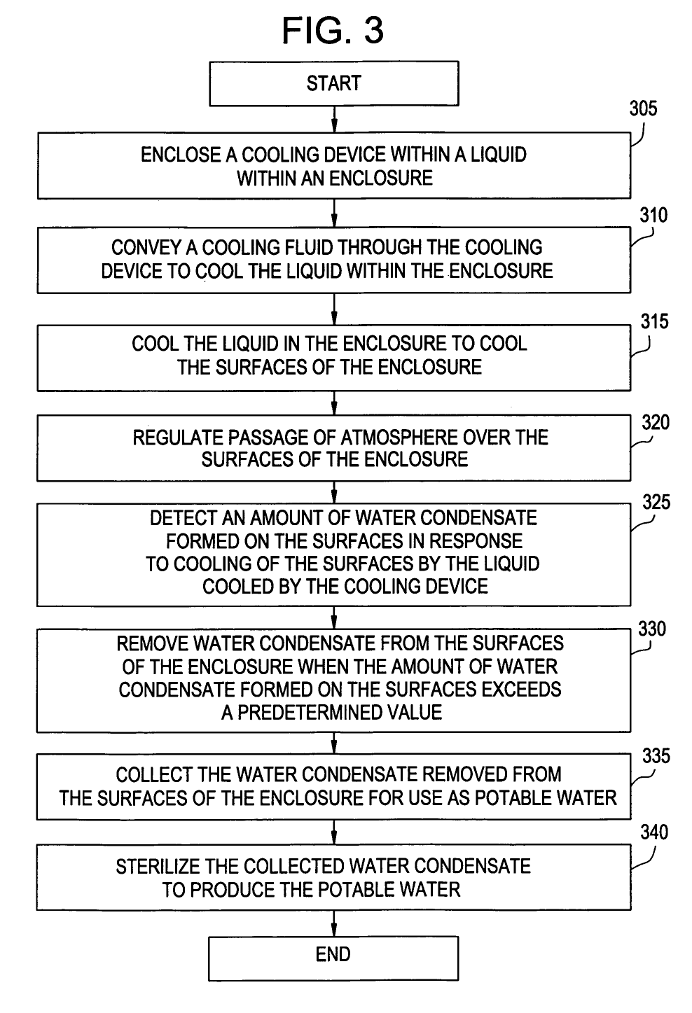

FIG. 3 is a flowchart illustrating steps for producing potable water from atmosphere, in accordance with an exemplary embodiment of the present invention. In step 305, a cooling device can be enclosed within a liquid within an enclosure. Surfaces of the enclosure can be comprised of a material on which water condensation from the atmosphere forms in response to a temperature differential between the material and the atmosphere. For example, the material can comprise glass, metal, plastic or the like. For example, the liquid can comprise water, alcohol or the like. In step 310, a cooling fluid can be conveyed through the cooling device to cool the liquid within the enclosure. In step 315, the liquid in the enclosure can be cooled to cool the surfaces of the enclosure. In step 320, a passage of atmosphere over the surfaces of the enclosure can be regulated. A volume of atmosphere passed over the surfaces of the enclosure can be dependent upon a humidity of the atmosphere. In step 325, an amount of water condensate formed on the surfaces in response to cooling of the surfaces by the liquid cooled by the cooling device can be detected. In step 330, water condensate can be removed from the surfaces of the enclosure when the amount of water condensate formed on the surfaces exceeds a predetermined value. In step 335, the water condensate removed from the surfaces of the enclosure can be collected for use as potable water. In step 340, the collected water condensate can be sterilized to produce the potable water.

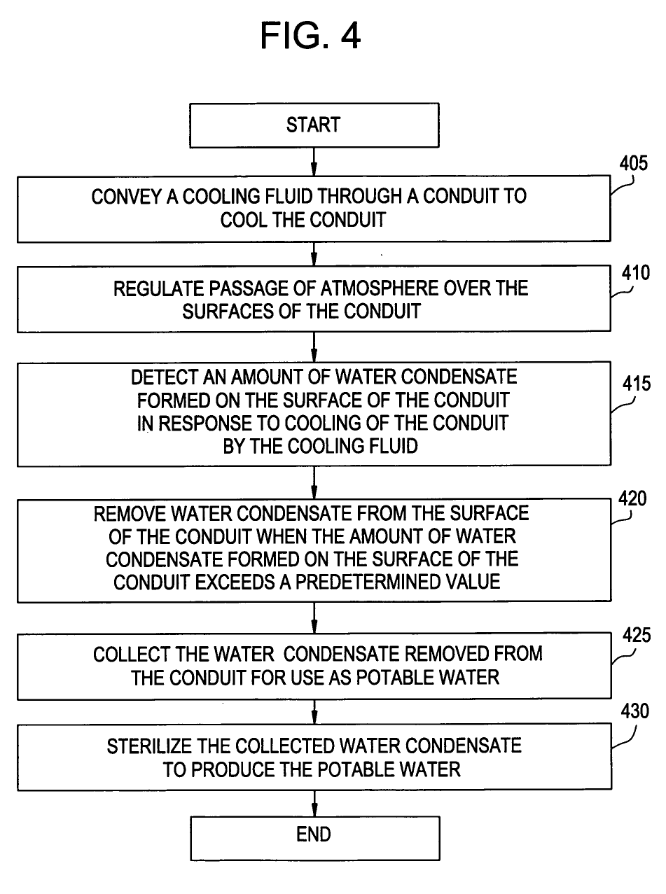

FIG. 4 is a flowchart illustrating steps for producing potable water from atmosphere, in accordance with an alternative exemplary embodiment of the present invention. In step 405, a cooling fluid can be conveyed through a conduit to cool the conduit. The conduit can be comprised of a material on which water condensation from the atmosphere forms in response to a temperature differential between the material and the atmosphere, such as, for example, glass, metal, plastic or the like. The conduit can of any suitable structure, such as a coil, tube or the like. The cooling fluid can be a refrigerant or the like. In step 410, a passage of atmosphere over the surface of the conduit can be regulated. A volume of atmosphere passed over the surface of the conduit can be dependent upon a humidity of the atmosphere. In step 415, an amount of water condensate formed on a surface of the conduit in response to cooling of the conduit by the cooling fluid can be detected. In step 420, water condensate can be removed from the surface of the conduit when the amount of water condensate formed on the surface of the conduit means exceeds a predetermined value. In step 425, the water condensate removed from the conduit means can be collected for use as potable water. In step 430, the collected water condensate can be sterilized to produce the potable water.

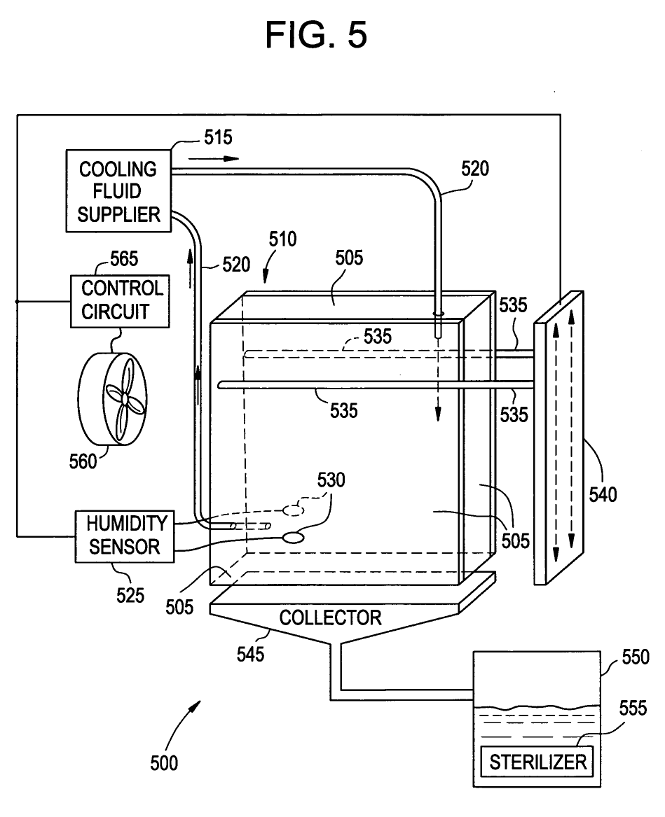

FIG. 5 is a diagram illustrating a system 500 for producing potable water from atmosphere, in accordance with an alternative exemplary embodiment of the present invention. The system 500 includes a plurality of surfaces 505 arranged to form a sealed enclosure 510. Each of the plurality of surfaces 505 can be comprised of a material on which water condensation from the atmosphere forms when there is a temperature differential between the material and the atmosphere. For example, each of the plurality of surfaces 505 can be comprised of glass, metal, plastic, or the like. Each of the plurality of surfaces 505 can be of any suitable configuration, such as substantially rectangular, substantially circular, substantially planar or the like.

The system 500 includes a cooling fluid supplier 515, such as a condenser or the like, in fluid communication with the sealed enclosure 510 for supplying a cooling fluid within the sealed enclosure 510. The cooling fluid can be, for example, water, alcohol, or other suitable cooling fluid. The cooling fluid supplier 515 can be configured to contain or otherwise store cooling fluid (e.g., as a tank) for supply to the sealed enclosure 510. The cooling fluid supplier 515 can be fluidly connected to the sealed enclosure 510 using, for example, pipes 520. According to an exemplary embodiment, one of the pipes 520 can be configured to bring cooling fluid from the cooling fluid supplier 515 to the sealed enclosure 510 (e.g., at or near the top of the sealed enclosure 510) to fill the sealed enclosure 510 with the cooling fluid. Another of the pipes 520 can be configured to return the cooling fluid from the sealed enclosure 510 (e.g., at or near the bottom of the sealed enclosure 510) to the cooling fluid supplier 515 for re-cooling and eventual re-supply to the sealed enclosure 510. Thus, the exemplary embodiment illustrated in FIG. 5 can provide a circulation system for circulating cooling fluid, in the sealed enclosure 510, that is cooled by the cooling fluid supplier 515.

The system 500 includes at least one humidity sensor 525 located proximate to the plurality of surfaces 505. The at least one humidity sensor 525 can be configured to detect an amount of water condensate formed on the plurality of surfaces 505. The at least one humidity sensor 525 can include, for example, a plurality of sensor pads 530 that rest on or near one or more of the plurality surfaces 505 and are in electrical communication with the at least one humidity sensor 525. Any appropriate number of sensor pads 530 can be placed in any suitable locations over the plurality of surfaces 505 to allow for a proper determination of the amount of water condensate formed on the surfaces.

The system 500 includes a plurality of wipers 535. Each of the plurality of wipers 535 can associated with a surface of the plurality of surfaces 505. Each of the plurality of wipers 535 can be configured to remove water condensate from each of the plurality of surfaces 505 when the at least one humidity sensor 525 detects the amount of water condensate formed on the plurality of surfaces 505 exceeds a predetermined value. Each of the plurality of wipers 535 can comprise a squeegee or any other suitable type of component capable of removing water from a surface, such as a brush or the like. The system 500 can include a wiper movement mechanism 540 that is configured to move the wipers 535 across each of the plurality of surfaces 505. For example, the wipers 535 can be initially positioned at or near the top of the plurality of surfaces 505 and wipe the surfaces in a downward direction (either concurrently or independently) to remove the water condensate, and then return to their respective initial positions. The wiper movement mechanism 540 can be in electrical communication with the at least one humidity sensor 525 using any suitable type of electrical connection. The wiper movement mechanism 540 can be comprised of any suitable electrical, electronic and/or mechanical means capable of moving the wipers 535.

The system 500 includes a collector 545 for collecting the water condensate removed from the plurality of surfaces 505 for use as potable water. The collector 545 can be any suitable form of trap, basin, drain or the like that is capable of capturing or otherwise collecting and temporarily storing the water condensate removed from the plurality of surfaces 505. The collector 545 can be located below the plurality of surfaces 505 to capture the falling water condensate as it is removed from the surfaces by the wipers 535. The collector 545 can include a tank 550 for storing the collected water condensate. The collector 545 can include a sterilizer 555 for sterilizing the collected water condensate to produce the potable water. The sterilizer 555 can be located, for example, in the tank 550 or separately from the tank 550. The sterilizer 555 can be any suitable device capable of sterilizing water, such as, for example, any suitable chemical means (e.g., chlorine), a heating element (e.g., to boil the water), an ultraviolet radiation emitter, or the like.

The system 500 can include an atmosphere flow regulator 560 for passing atmosphere over the plurality of surfaces. The atmosphere flow regulator 560 can be any suitable type of electrical, electronic or mechanical means capable of moving air over the plurality of surfaces 505, such as, for example, a fan, a blower, or the like. The system 500 can also include a control circuit 565 for controlling the atmosphere flow regulator 560 to control the passage of atmosphere over the plurality of surfaces 505. The control circuit 565 can be comprised of any suitable digital, analog, or mechanical means that is capable of controlling the rate of air flow produced by the atmosphere flow regulator 560. According to exemplary embodiments, the volume of atmosphere passed over the plurality of surfaces 505 can be dependent upon, for example, the humidity of the atmosphere detected by the at least one humidity sensor 525 (e.g., the volume of atmosphere passed over the surfaces can increase as the relative humidity decreases and vice versa). The at least one humidity sensor 525, the control circuit 565 and the wiper movement mechanism 540 can all be in electrical communication with each other using any suitable type of electrical connection.

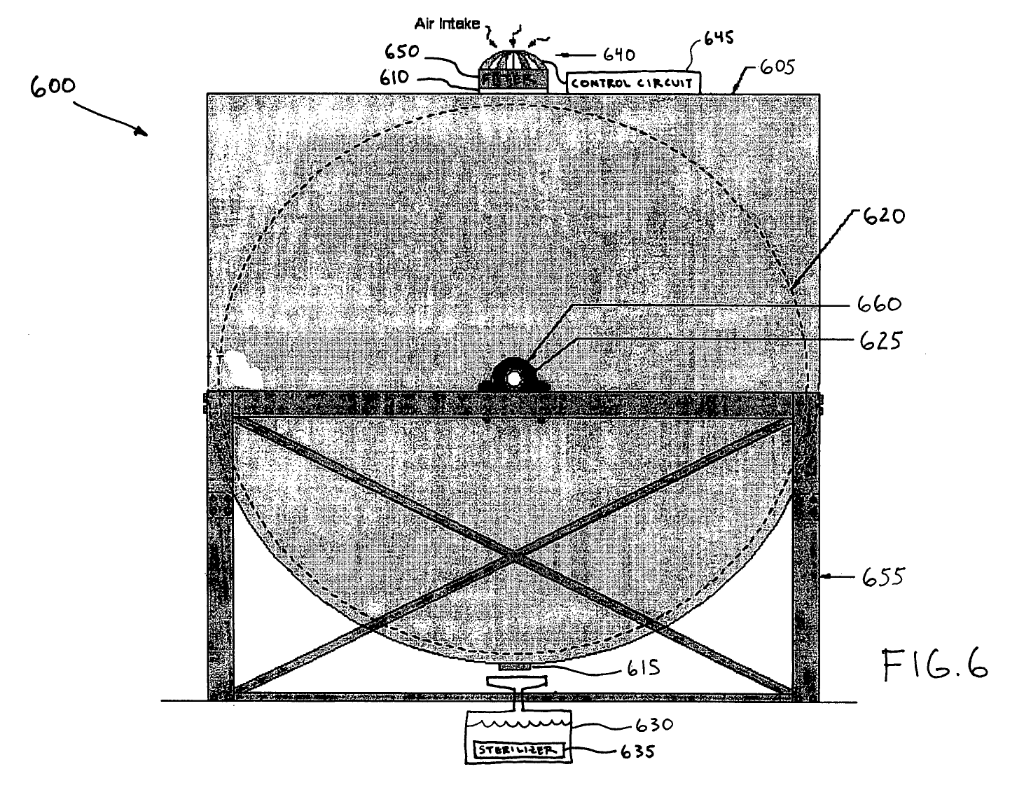

FIG. 6 is a diagram illustrating a system 600 for producing potable water from atmosphere, in accordance with an alternative exemplary embodiment of the present invention. The system 600 includes an enclosure 605. The enclosure 605 includes at least one intake port 610. The intake port 610 is configured to allow air or fluid to enter the enclosure 605. However, the intake port 610 is sealable (e.g., using a valve or other suitable form of seal), upon activation, to prevent fluids from escaping from the enclosure 605. The enclosure 605 includes at least one exhaust port 615. The exhaust port 615 is configured to allow air or fluid to exit the enclosure 605. However, the exhaust port 615 is sealable (e.g., using a valve or other suitable form of seal), upon activation, to prevent fluids from escaping from the enclosure 615. The system 600 includes a plurality of panels 620 arranged within the enclosure 605 substantially parallel to each other along a central axis 625. Each of the plurality of panels 620 is comprised of a material on which water condensate from the atmosphere forms in response to a temperature differential between the material and the atmosphere passed through the enclosure 605. For example, each of the plurality of panels 620 can be comprised of metal (e.g., aluminum or other like metal), plastic, glass or the like. According to an exemplary embodiment, the enclosure 605 can comprise a radiator or the like, with each of the plurality of panels 620 comprising a fin or the like of the radiator. The enclosure 605 can be of any suitable shape and size, depending upon, for example, the shape of the panels 620, the desired amount of water production by the system 600, and other like factors.

According to an alternative exemplary embodiment, the plurality of panels 620 can comprise a plurality of cooling surfaces. The plurality of cooling surfaces can be comprised of, for example, interlacing meshes of cooling strands, such as strands or filaments of metal (e.g., aluminum or the like). The interlacing meshes of cooling strands can be akin to, for example, “steel wool” or the like interwoven structures. However, other suitable forms of condensation filters can be used.

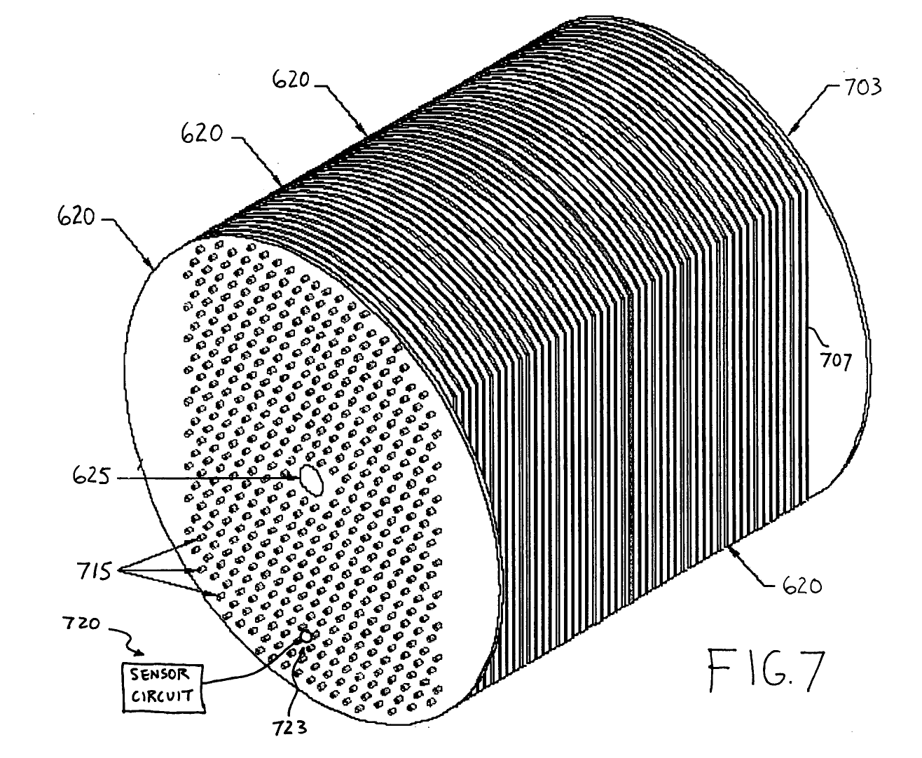

FIG. 7 is a diagram illustrating the plurality of panels 620 used for producing potable water from atmosphere, in accordance with the alternative exemplary embodiment of the present invention. Each of the plurality of panels 620 can be separated from an adjacent panel 620 by a predetermined distance. For example, according to one exemplary embodiment, the predetermined distance between panels 620 can be between approximately five millimeters and approximately seven millimeters, although the panels 620 can be separated from each other by any suitable amount. The plurality of panels 620 can be of any suitable diameter and thickness. For example, according to one exemplary embodiment, each of the plurality of panels 620 can be approximately 1.7 meters in diameter and approximately one quarter of an inch thick.

The shape of each of the plurality of panels 620 can be configured to fit within the enclosure 605. For example, each of the plurality of panels 620 can be substantially circular in shape. According to this exemplary embodiment, if each panel 620 is approximately 1.7 meters in diameter, the area of each side of each panel 620 would be approximately 2.25 square meters, with the total surface area of each panel 620 being approximately 4.5 square meters. However, as illustrated in FIG. 7, each of the plurality of panels 620 can be comprised of two pairs of opposing edges. A first pair of opposing edges 703 can be curved, while a second pair of opposing edges 707 can be substantially straight. According to this alternative exemplary embodiment, if each panel 620 is approximately 1.7 meters in diameter, the area of each side of each panel 620 would be approximately 1.85 square meters in area, with the total surface area of each panel 620 being approximately 3.7 square meters (e.g., each of the straight edges 707 can be approximately 1.2 meters in length). Other configurations of the plurality of panels 620 can be used, depending on factors, such as, for example, the shape of the enclosure 605, the desired amount of water to be produced by the system 600, and the like. Any suitable number of panels can be used, depending on the desired amount of water to be produced by the system 600. For example, according to one exemplary embodiment, approximately 600 square meters of total surface area can be used for the plurality of panels 620, resulting in approximately 133 panels 620 (e.g., if circular panels are used) or 163 panels 620 (e.g., if panels 620 with the configuration illustrated in FIG. 7 are used). Using approximately 600 square meters of total surface area to form water condensate, the system 600 can produce approximately 1200 liters of potable water per hour.

Continuing with the illustration of FIG. 7, the system 600 includes a plurality of conduits 715 arranged to pass through the plurality of panels 620. According to an exemplary embodiment, the plurality of conduits 715 can penetrate the plurality of panels 620 substantially perpendicular to the plurality of panels 620. The plurality of conduits 715 can be arranged substantially parallel to the central axis 625. However, the plurality of conduits 715 can be arranged in any suitable manner to penetrate the plurality of panels 620. Each of the plurality of conduits 715 can be separated from an adjacent conduit 715 by a predetermined distance. For example, according to one exemplary embodiment, the predetermined distance between conduits 715 can be approximately two inches, although the conduits 715 can be separated from each other by any suitable amount. Each conduit 715 can be of any suitable diameter. According to one exemplary embodiment, each conduit 715 can be approximately ⅜ inches in diameter. Any suitable number of conduits 715 can be used, depending on, for example, the desired amount of water to be produced by the system 600, the size of the panels 620, the amount of cooling required, and the like. For example, according to one exemplary embodiment, approximately 536 conduits can be used, if each panel 620 is approximately 1.7 meters in diameter, with curved edges 703 and straight edges 707 (as illustrated in FIG. 7).

According to exemplary embodiments, a cooling fluid can be passed through each of the plurality of conduits 715 to cool the plurality of panels 620. The cooling fluid can be comprised of any suitable liquid or fluid that is capable of cooling, such as, for example, water, a freon substitute or the like. Each of the conduits 715 can be comprised of any suitable material capable of being cooled, such as, for example, metal (e.g., aluminum, copper or the like), plastic or the like. The plurality of conduits 715 can be in fluid communication with each other. In other words, the plurality of conduits 715 can be comprised of a single continuous conduit that is “woven” through the plurality of panels 620, having one ingress through which the cooling fluid enters and one egress through which the cooling fluid exits. However, other configurations of the plurality of conduits 715 can be used. For example, the plurality of conduits 715 can be comprised of a plurality of separate pipes, in which the cooling fluid is separately passed through each of the plurality of pipes to cool the plurality of panels 620.

According to exemplary embodiments, an amount of the water condensate formed on surfaces of the plurality of panels 620 in response to cooling can be detected. For example, the system 600 can include a sensor circuit 720 located proximate to the plurality of panels 620. The sensor circuit 720, such as a humidity sensor or other suitable electrical or electronic device, is configured to detect the amount of the water condensate formed on the surfaces of the plurality of panels 620 in response to cooling. The sensor circuit 720 can be connected to one or more sensor pads 723 located on or near surfaces of the plurality of panels 620. Any suitable number of sensor pads 723 can be used for detecting the amount of water condensate formed on the surfaces of the plurality of panels 620. For example, a sensor pad 723 can be located on or near each surface of each panel 620, although a subset of the plurality of panels 620 can have a sensor pad 723 located on or near those panels. Additionally or alternatively, sensor pads 723 can be located within the enclosure 605 near the panels 620 to allow the sensor circuit 720 to detect the humidity within the enclosure 605. Additionally or alternatively, a plurality of sensor circuits 720 can be used. The sensor circuit(s) 720 can be located in, on or near the enclosure 605.

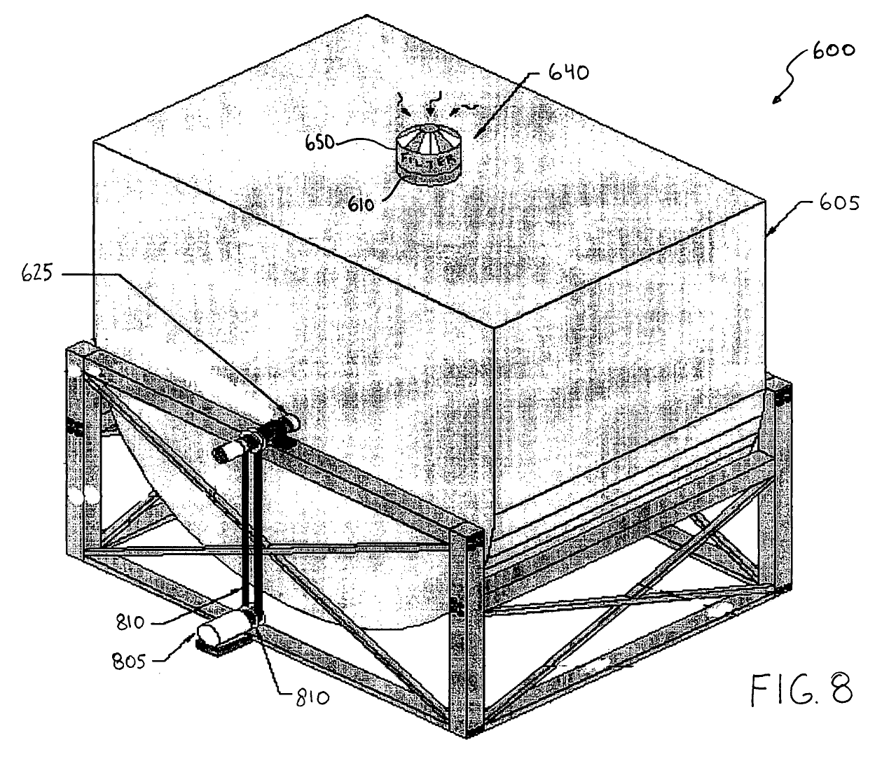

According to exemplary embodiments, the plurality of panels 620 are configured to be rotated about the central axis 625 within the enclosure 605 to remove the water condensate from the surfaces of the plurality of panels 620 when the detected amount of the water condensate exceeds a predetermined threshold. FIG. 8 is a diagram illustrating an angled view of the system 600 for producing potable water from atmosphere, in accordance with an alternative exemplary embodiment of the present invention. The system 600 can include a rotation device 805 in connection with the central axis 625. The sensor circuit 720 can be in electrical communication with the rotation device 805. The rotation device 805 is configured to turn the central axis 625 to rotate the plurality of panels 620 within the enclosure 605. The rotation device 805 can comprise, for example, a motor or the like that can be connected to the central axis 625 using any suitable form of connection means 810, such as, for example, a pulley and belt system, gears, chains, pinions or the like. Thus, when the sensor circuit 720 detects that the amount of water condensate formed on the plurality of panels 620 exceeds the predetermined threshold, the rotation device 805 can be activated to spin, turn or otherwise rotate the plurality of panels 620 at sufficient revolutions per minute to remove the water condensate from the surfaces of the plurality of panels 620 through centrifugal force. The predetermined threshold can be any suitable humidity level, depending on the desired amount of water production, the relative humidity of the air entering the enclosure 605, and other like factors.

According to exemplary embodiments, air is passed through the intake port 610 into the enclosure 605, over the plurality of panels 605, and out the exhaust port 615. Due to the temperature differential between the cooled plurality of panels 620 and the air, water condensate forms on the surfaces of the plurality of panels 620. Once the amount of water condensate formed on the plurality of panels 620 exceeds the predetermined threshold (as detected by the sensor circuit 720), the intake port 610 and exhaust port 615 can be sealed. The plurality of panels 620 are then rotated or otherwise spun by the rotation device 805. The water condensate is removed from the surfaces of the panels 620 through centrifugal force and collects in the enclosure 605, such as at the bottom of the enclosure around the (sealed) exhaust port 615. After the rotation of the panels 620 is stopped (e.g., after a predetermined length of time, when the sensor circuit 720 detects that the amount of water condensate has dropped below a certain minimum level, or the like), the intake port 610 and exhaust port 615 can be opened. The water condensate that has collected in the enclosure can then exit the enclosure through the exhaust port 615 located on the bottom of the enclosure 605. Referring to FIG. 6, the system 600 can include a collector 630. The collector 630 is configured to hold the collected water condensate removed from the surfaces of the plurality of panels 620 that is passed out of the exhaust port 615, after rotation of the enclosure 605. In addition, the system can include a sterilizer 635, for example, located in or near the collector 630. The sterilizer 635 is configured to sterilize the collected water condensate to produce the potable water. The sterilizer 635 can be any suitable device capable of sterilizing water, such as, for example, any suitable chemical means (e.g., chlorine), a heating element (e.g., to boil the water), an ultraviolet radiation emitter, or the like.

The system 600 can include an atmosphere flow regulator 640. The atmosphere flow regulator 640 is configured to pass the atmosphere through the intake port 620 into the enclosure 605 and over the surfaces of the plurality of panels 620. The atmosphere flow regulator 640 can be any suitable type of electrical, electronic or mechanical means capable of moving air into the enclosure 605 and over the surfaces of the panels 620, such as, for example, a fan, a turbine fan, a blower, or the like. The system 600 can also include a control circuit 645 in electrical communication with the atmosphere flow regulator 640. The control circuit 645 is configured to control the atmosphere flow regulator 640 to control a passage of the atmosphere into the enclosure 605 and over the surfaces of the plurality of panels 620. The control circuit 645 can be comprised of any suitable digital, analog, or mechanical means that is capable of controlling the rate of air flow produced by the atmosphere flow regulator 640. According to exemplary embodiments, the volume of atmosphere passed into the enclosure 605 and over the surfaces of the panels 620 can be dependent upon, for example, the humidity of the atmosphere detected by the sensor circuit 720 (e.g., the volume of atmosphere passed over the surfaces can increase as the relative humidity decreases and vice versa).

For example, the control circuit 645 can be in electrical communication with the sensor circuit 720 using any suitable form of electrical connection. If the sensor circuit 720 detects that, for example, the rate of water condensation on the surfaces of the panels 620 is decreasing (e.g., the interval between rotations is increasing) or the rate of water production is below a desired rate or threshold (e.g., the relative humidity of the atmosphere is decreasing), the sensor circuit 720 can send an electrical signal or command to the control circuit 645 to increase the rate of air flow from the atmosphere flow regulator 640. Alternatively, if the sensor circuit 720 detects that, for example, the rate of water condensation on the surfaces of the panels 620 is increasing (e.g., the interval between rotations is decreasing) or the rate of water production is above a desired rate or threshold (e.g., the relative humidity of the atmosphere is increasing), the sensor circuit 720 can send an electrical signal or command to the control circuit 645 to decrease the rate of air flow from the atmosphere flow regulator 640 to maintain a steady or substantially constant production of potable water. According to an exemplary embodiment, the system 600 can include an atmosphere filtration device 650. The atmosphere filtration device 650 is configured to filter the atmosphere passed into the enclosure 605 via the intake port 610, such as, for example, any suitable form of air or fluid filter (e.g., an electrostatic air filter or the like).

The sensor circuit 720 can control the atmosphere flow regulator 640 to control the rate of air flow into the enclosure 605 in any suitable manner. For example, according to one exemplary embodiment, the rate of air flow can be calculated by the sensor circuit 720 using a Mollier diagram for humid air. A Mollier diagram for humid air represents the correlation between air temperature, water content and humidity. Mollier diagrams are well-known in the art, and are described in, for example, U.S. Pat. Nos. 6,619,053, 6,390,183, 6,101,823, 5,524,455, 5,245,843, 4,146,372 and 3,939,905. The Mollier diagram is based on several factors, including relative humidity, ambient air temperature, temperature at which condensation occurs and rate of air flow. According to an exemplary embodiment, the sensor circuit 720 can include any suitable type of computer memory to store, for example, relative humidity and ambient air temperature values for the suitable Mollier diagram. For example, the sensor circuit 720 can include or be in communication with relative humidity and ambient air temperature sensors to measure those values with respect to air entering and in the enclosure 605. The sensor circuit 720 can include any suitable type of microprocessor to calculate the temperature at which condensation occurs and the rate of air flow necessary to cause condensation, based on the measured values of relative humidity and ambient air temperature. For example, the microprocessor can access a look-up table or the like stored in the computer memory to retrieve or otherwise calculate the corresponding values of the temperature at which condensation occurs and rate of air flow necessary to cause condensation based on the Mollier diagram, using the measured values of relative humidity and ambient air temperature. Once calculated, the sensor circuit 720 can control the atmosphere flow regulator 640 to control the rate of air flow into the enclosure 605 to achieve the desired rate of air flow and condensation. Thus, the system 600 can be configured to achieve the maximum rate of condensation to generate the desired amount of potable water production per hour.

The microprocessor that can be used or otherwise associated with sensor circuit 720 can be any suitable type of processor, such as, for example, any type of general purpose microprocessor or microcontroller, a digital signal processing (DSP) processor, an application-specific integrated circuit (ASIC), a programmable read-only memory (PROM), an erasable programmable read-only memory (EPROM), an electrically-erasable programmable read-only memory (EEPROM), a computer-readable medium, or the like. The memory that can be used or otherwise associated with sensor circuit 720 can be any suitable type of computer memory or any other type of electronic storage medium, such as, for example, read-only memory (ROM), random access memory (RAM), cache memory, compact disc read-only memory (CDROM), electro-optical memory, magneto-optical memory, any suitable form of data storage card or the like. As will be appreciated based on the foregoing description, the memory can be programmed using conventional techniques known to those having ordinary skill in the art of computer programming. For example, the actual source code or object code of the computer program can be stored in the memory.

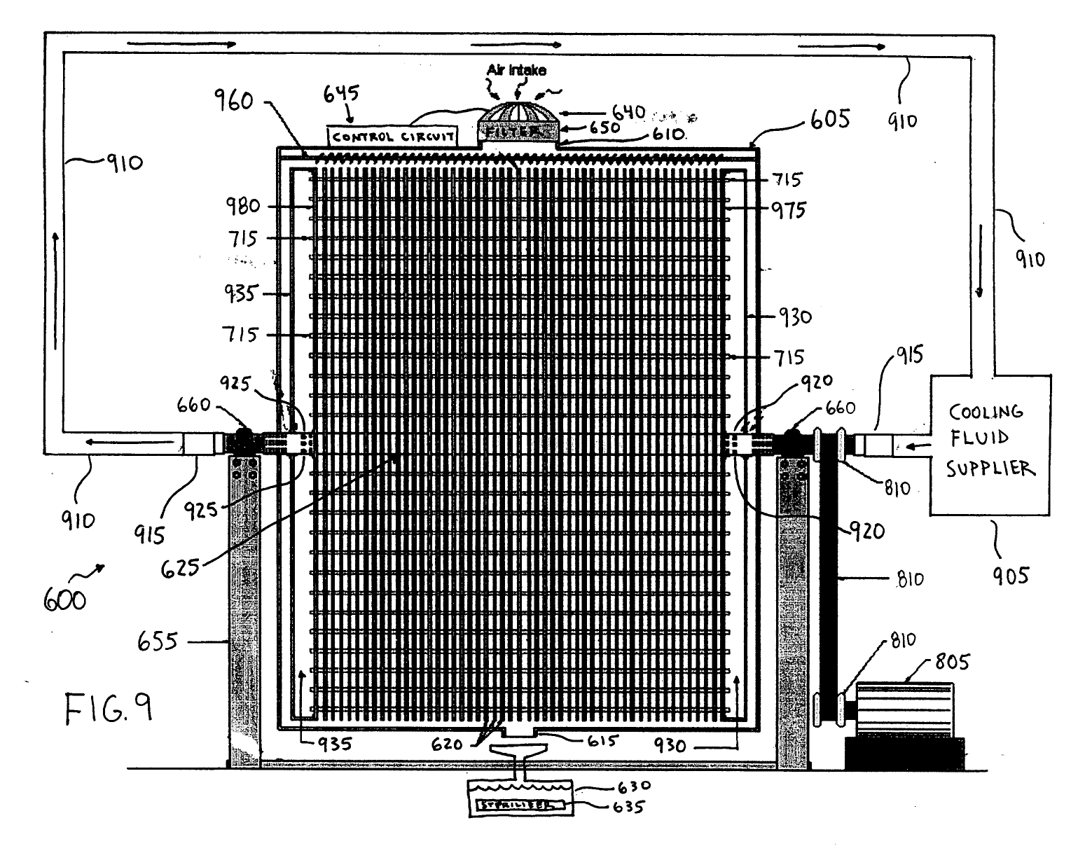

FIG. 9 is a diagram illustrating a cut-away side view of the system 600 for producing potable water from atmosphere, in accordance with an alternative exemplary embodiment of the present invention. The system 600 can include a cooling fluid supplier 905 (e.g., a condenser or the like). The cooling fluid supplier 905 is configured to supply the cooling fluid through the plurality of conduits 715 to cool the plurality of panels 620. For example, the central axis 625 can comprise a supply conduit. The supply conduit can be of any suitable diameter, such as, for example, 2.5 inches, and of any suitable length, such as, for example, 1.27 meters. The cooling fluid supplier 905 is connected to either end of the supply conduit using, for example, a supply line 910 and, for example, rotating heads 915 or other suitable rotatable fluid connection links or means.

According to one exemplary embodiment, the supply conduit includes holes or perforations 920 and 925 located inside the enclosure 605 within first and second chambers 930 and 935, respectively. The cooling fluid enters the enclosure 605 through a first end of the supply conduit to be passed through the plurality of conduits 620. Once in the first end of the supply conduit, the cooling fluid is dispersed inside the first chamber 930 through the holes 920. For example, the supply conduit can be solid along the length between the holes 920 and 925, so that fluid does not pass through the supply conduit past the holes 920, but, rather, into the first chamber 930. The first chamber 930 forms a sealed enclosure outside a first panel 975 of the plurality of panels 620, into which one end of each of the conduits 715 opens. The cooling fluid enters and passes through each of the conduits 715 to cool the panels 620. The cooling fluid then exits the opposite end of each of the conduits 715 into the second chamber 935. The second chamber 935 forms a sealed enclosure outside a last panel 980 of the plurality of panels 620, into which the opposite end of each of the conduits 715 opens. Thus, the cooling fluid exits the enclosure 605 from the plurality of conduits 715 through a second end of the supply conduit. The cooling fluid reenters the supply conduit through the holes 925, passes out of the supply conduit through a (second) rotating head 915 into the supply line 910 for return to, and subsequent re-cooling by, the cooling fluid supplier 905.

As discussed previously, each of the conduits 715 can be in fluid communication with the other conduits 715, thereby forming a single, continuous conduit 715. In such an embodiment, the cooling fluid can enter one end of the continuous conduit 715 that opens into the first chamber 930, and exit the other end of the continuous conduit 715 that opens into the second chamber 935. Other configurations for supplying the cooling fluid to cool the panels 620 can be used.

Referring to FIG. 6, the system 600 can include an enclosure support 655 configured to support the enclosure 605. For example, the enclosure support 655 can be configured to anchor or otherwise support the enclosure 605 at opposing ends of the central axis 625 using anchors 660. The anchors 660 are configured to allow the central axis 625 to rotate when turned by rotation device 805 (e.g., as bearings or the like). Other configurations of the system 600 can be used. For example, as illustrated in FIG. 9, the system 600 can include an air diffuser 960 located within the enclosure near the intake port 610. The air diffuser 960 can be configured to ensure that the air entering the enclosure 605 through the intake port 610 is substantially equally diffused or otherwise disbursed over all of the plurality of panels 620.

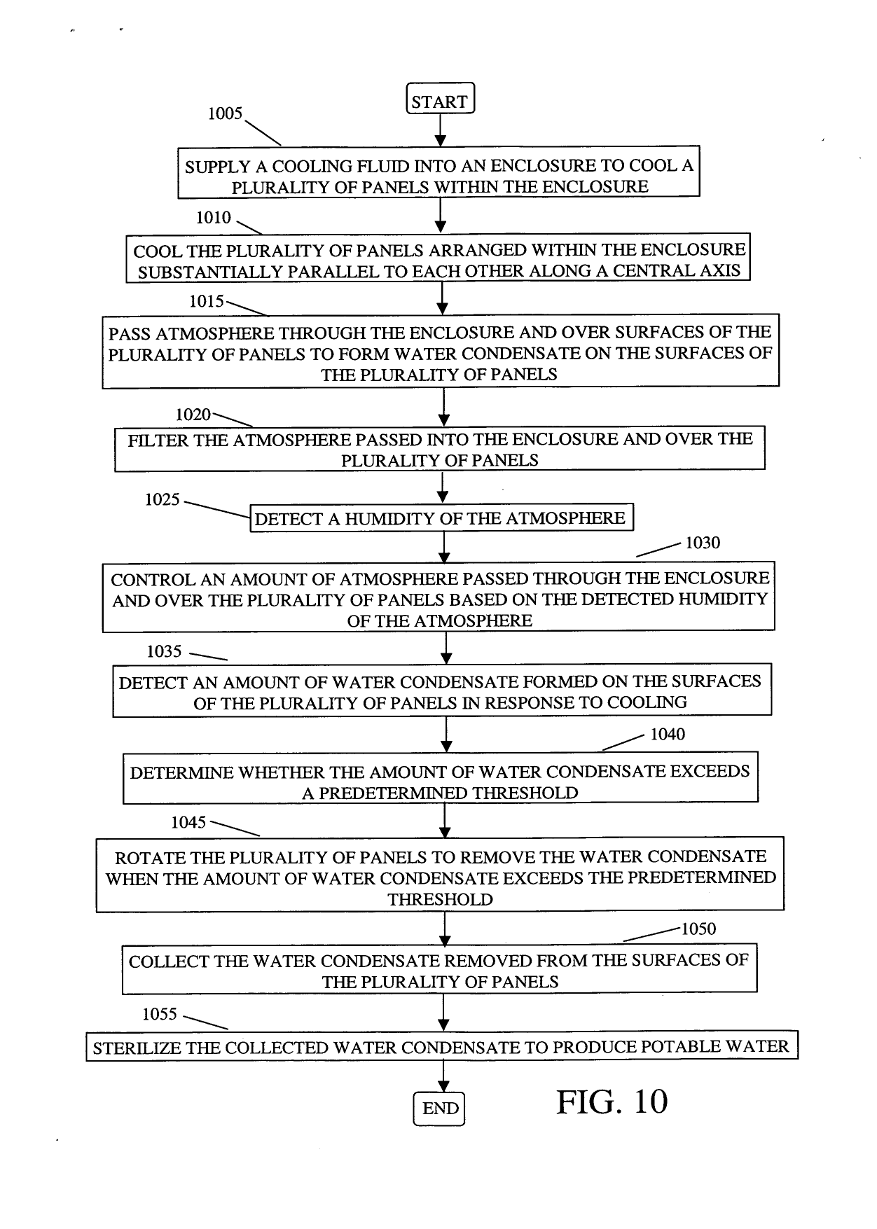

FIG. 10 is a flowchart illustrating steps for producing potable water from atmosphere, in accordance with an alternative exemplary embodiment of the present invention. In step 1005, a cooling fluid is supplied into an enclosure to cool a plurality of panels. In step 1010, the plurality of panels, arranged within the enclosure substantially parallel to each other along a central axis, are cooled. Each of the plurality of panels is comprised of a material on which water condensate from the atmosphere forms in response to a temperature differential between the material and the atmosphere passed through the enclosure. In step 1015, atmosphere is passed through the enclosure and over surfaces of the plurality of panels to form the water condensate on surfaces of the plurality of panels. In step 1020, the atmosphere passed into the enclosure and over the plurality of panels is filtered. In step 1025, a humidity of the atmosphere is detected. In step 1030, an amount of atmosphere passed through the enclosure and over the plurality of panels is controlled based upon the humidity of the atmosphere detected in step 1025. In step 1035, an amount of the water condensate formed on the surfaces of the plurality of panels in response to cooling is detected. In step 1040, a determination is made as to whether the amount of the water condensate formed on the surfaces of the plurality of panels exceeds a predetermined threshold. In step 1045, the plurality of panels are rotated about the central axis within the enclosure to remove the water condensate from the surfaces of the plurality of panels when the amount of the water condensate formed on the surfaces of the plurality of panels exceeds the predetermined threshold. In step 1050, the water condensate removed from the surfaces of the plurality of panels is collected. In step 1055, the collected water condensate is sterilized to produce the potable water.

Exemplary embodiments of the present invention can be used for producing potable water in any area of the world where potable water is needed. For purposes of illustration and not limitation, for the embodiment illustrated in FIG. 5, the system 500 can be comprised of two surfaces 505, each surface being approximately four feet wide and six feet long. Each of the two surfaces 505 can be comprised of tempered glass approximately one-quarter inch thick and sealed to the other surface to form an enclosure that is also one-quarter of an inch thick (for holding the cooling fluid), for a total thickness of three-quarters of an inch for the sealed enclosure 510. Numerous such enclosures can be used together. For example, twenty-nine such enclosures can be held in, for example, a cage that is approximately seven feet by five feet. By appropriately controlling the flow of atmosphere over the surfaces of the enclosures using the atmosphere flow regulator 560 (depending on the amount of humidity in the area the system is being used), exemplary embodiments of the present invention are capable of producing approximately 100 liters of potable water per hour.

Additionally, exemplary embodiments can be transported and assembled in a number of remote areas inhabited by humans where little or no natural resources are available for producing potable water. Furthermore, exemplary embodiments of the present invention can be accessible to individuals with limited technical expertise and be available in a range of sizes so that it can be used in areas that lack abundant space.

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

All United States patents and applications, foreign patents, and publications discussed above are hereby incorporated herein by reference in their entireties.

What is claimed is:

1. A system for producing potable water from atmosphere, comprising:
an enclosure,
wherein the enclosure comprises:
at least one sealable intake port; and
at least one sealable exhaust port;
a plurality of panels arranged within the enclosure substantially parallel to each other along a central axis,
wherein each of the plurality of panels is comprised of a material on which water condensate from the atmosphere forms in response to a temperature differential between the material and the atmosphere passed through the enclosure; and
a plurality of conduits arranged to pass through the plurality of panels,
wherein a cooling fluid is passed through the plurality of conduits to cool the plurality of panels,
wherein an amount of the water condensate formed on surfaces of the plurality of panels in response to cooling is detected, and
wherein the plurality of panels are configured to be rotated about the central axis within the enclosure to remove the water condensate from the surfaces of the plurality of panels when the detected amount of the water condensate exceeds a predetermined threshold.

2. The system of claim 1, comprising:
a sensor circuit located proximate to the plurality of panels,
wherein the sensor circuit is configured to detect the amount of the water condensate formed on the surfaces of the plurality of panels in response to cooling.

3. The system of claim 2, comprising:
an atmosphere flow regulator,
wherein the atmosphere flow regulator is configured to pass the atmosphere through the at least one sealable intake port into the enclosure and over the surfaces of the plurality of panels.

4. The system of claim 3, comprising:
a control circuit in communication with the atmosphere flow regulator,
wherein the control circuit is configured to control the atmosphere flow regulator to control a passage of the atmosphere over the surfaces of the plurality of panels, and
wherein a volume of atmosphere passed over the surfaces of the plurality of panels is dependent upon a humidity of the atmosphere detected by the sensor circuit.

5. The system of claim 1, wherein the plurality of conduits penetrate the plurality of panels substantially perpendicular to the plurality of panels, and
wherein the plurality of conduits are arranged substantially parallel to the central axis.

6. The system of claim 1, wherein each of the plurality of panels is separated from an adjacent panel by a predetermined distance.

7. The system of claim 1, wherein each of the plurality of conduits is separated from an adjacent conduit by a predetermined distance.

8. The system of claim 1, wherein each of the plurality of panels comprises metal.

9. The system of claim 8, wherein the metal comprises aluminum.

10. The system of claim 1, wherein each of the plurality of conduits comprises metal.

11. The system of claim 1, wherein the cooling fluid comprises water.

12. The system of claim 1, wherein each of the plurality of panels comprises two pairs of opposing edges,
wherein a first pair of opposing edges is curved, and
wherein a second pair of opposing edges is substantially straight.

13. The system of claim 1, wherein the plurality of conduits are in fluid communication with each other.

14. The system of claim 1, comprising:
an atmosphere filtration device,
wherein the atmosphere filtration device is configured to filter the atmosphere passed into the enclosure via the at least one sealable intake port.

15. The system of claim 1, comprising:
a collector,
wherein the collector is configured to hold collected water condensate removed from the surfaces of the plurality of panels that is passed out of the at least one sealable exhaust port, after rotation of the enclosure.

16. The system of claim 15, comprising:
a sterilizer,
wherein the sterilizer is configured to sterilize the collected water condensate to produce the potable water.

17. The system of claim 1, comprising:
a cooling fluid supplier,
wherein the cooling fluid supplier is configured to supply the cooling fluid through the plurality of conduits to cool the plurality of panels.

18. The system of claim 1, wherein the system comprises:
a rotation device in connection with the central axis,
wherein the rotation device is configured to turn the central axis to rotate the plurality of panels within the enclosure.

19. The system of claim 1, comprising:
an enclosure support configured to support the enclosure.

20. The system of claim 1, wherein the central axis comprises a supply conduit,
wherein the supply conduit is in fluid communication with the plurality of conduits,
wherein the cooling fluid enters the enclosure through a first end of the supply conduit to be passed through the plurality of conduits, and
wherein the cooling fluid exits the enclosure from the plurality of conduits through a second end of the supply conduit.

21. A method of producing potable water from atmosphere, comprising the steps of:
a.) cooling a plurality of panels arranged within an enclosure substantially parallel to each other along a central axis,
wherein each of the plurality of panels is comprised of a material on which water condensate from the atmosphere forms in response to a temperature differential between the material and the atmosphere passed through the enclosure;
b.) passing atmosphere through the enclosure and over surfaces of the plurality of panels to form the water condensate on surfaces of the plurality of panels;
c.) detecting an amount of the water condensate formed on the surfaces of the plurality of panels in response to cooling;
d.) determining whether the amount of the water condensate formed on the surfaces of the plurality of panels exceeds a predetermined threshold; and
e.) rotating the plurality of panels about the central axis within the enclosure to remove the water condensate from the surfaces of the plurality of panels when the amount of the water condensate formed on the surfaces of the plurality of panels exceeds the predetermined threshold.

22. The method of claim 21, comprising the step of:
f.) detecting a humidity of the atmosphere; and
g.) controlling an amount of atmosphere passed through the enclosure and over the plurality of panels based upon the humidity of the atmosphere detected in step (f).

23. The method of claim 21, comprising the step of:
f.) filtering the atmosphere passed into the enclosure and over the plurality of panels.

24. The method of claim 21, comprising the step of:
f.) collecting the water condensate removed from the surfaces of the plurality of panels.

25. The method of claim 24, comprising the method of:
g.) sterilizing the collected water condensate to produce the potable water.

26. The method of claim 21, comprising the step of:
f.) supplying a cooling fluid into the enclosure to cool the plurality of panels.

27. A system for producing potable water from atmosphere, comprising:
an enclosure,
wherein the enclosure comprises:
an intake port; and
an exhaust port;
a plurality of cooling surfaces arranged within the enclosure about a central axis
wherein the plurality of cooling surfaces are comprised of a material on which water condensate from the atmosphere forms in response to a temperature differential between the material and the atmosphere passed through the enclosure; and
a plurality of conduits arranged within the enclosure,
wherein the plurality of conduits are arranged to pass through the plurality of cooling surfaces,
wherein a cooling fluid is passed through the plurality of conduits to cool the plurality of cooling surfaces,
wherein an amount of the water condensate formed on the plurality of cooling surfaces in response to cooling is detected, and
wherein the plurality of cooling surfaces are configured to be rotated about the central axis within the enclosure to remove the water condensate from the plurality of cooling surfaces when the detected amount of the water condensate exceeds a predetermined threshold.

28. The system of claim 27, wherein the plurality of cooling surfaces comprises interlacing meshes of cooling strands.
